(19) United States
(12) Patent Application Publication
(10) Pub. No.: US 2024/0109174 A1
(43) Pub. Date: Apr. 4, 2024

(54) EXTENSION HANDLE SYSTEM FOR HANDHELD POWER TOOLS

(71) Applicant: Daniel L. YALACKI, Aurora, CO (US)

(72) Inventor: Daniel L. YALACKI, Aurora, CO (US)

(21) Appl. No.: 18/257,587

(22) PCT Filed: Feb. 18, 2022
(86) PCT No.: PCT/US2022/017105

§ 371 Date: Jun. 15, 2023

Related U.S. Application Data
(60) Provisional application No. 63/127,209, filed on Dec. 18, 2020.

(51) Int. Cl. B25F 5/02

(52) U.S. Cl. CPC B25F 5/021

(57) ABSTRACT

An extension handle system for a handheld power tool, such as a right-angle grinder, having an extension shaft with a fork assembly attached to one end for pivotably mounting the power tool, a main handle with power outlets for the tool and an extension cord, and means on the main handle to route the power cord in a way allowing the user to control the forward and backward tilt of the grinder with one or more fingers pulling on the cord. An assist handle is attached on the shaft for stability and side-to-side tilting and control of the grinder. Accessories include shrouds for vertical cutting or horizontal grinding and cutting, a shroud permitting mounting of a palm sander to the fork assembly, a slide or skate assembly for accurate vertical cutting, and a variable speed controller for speed reduction of sanders or grinders.

### REFERENCE TO RELATED APPLICATIONS

This application claims priority from U.S. Provisional Application No. 63/127,209 filed Dec. 18, 2020, titled “Grinder on a Stick,” by Daniel L. Yalacki, the entire contents of which are hereby incorporated herein by reference.

### BACKGROUND OF THE INVENTION

This invention relates generally to an extension handle system for stand-up operation of handheld power tools, more particularly to extension handle systems for angle grinders, orbital sanders, and other power tools.

The right-angle grinder (also simply known as an angle grinder or grinder) was reportedly invented in Germany in 1954. The angle grinder is designed to be a handheld power tool and requires two hands to properly and safely operate. One hand holds the main trigger handle with which an operator may lift and level the tool to cause the blade or cutters to lay evenly on the grinding surface. The other hand holds an assist handle mounted to the side of the grinder with which one maintains control over the head of the grinder. FIG. 1 illustrates a typical right-angle grinder. In FIG. 1, grinder 100 includes head 102 and main grip or handle 103 on motor body 101. On/off power trigger 104 on handle 103 often includes a means to lock it on. Power cord 108 extends from the end of handle 103. Head 102 includes a threaded hole 105 on each side thereof for attaching an auxiliary handle on one side. Various types of circular blades or pads, for various types of cutting, abrading, grinding, or polishing operations may be mounted on arbor 107. Arbor mount 106 is available for mounting a blade guard.

To operate a conventional handheld, right-angle grinder involves the combination of simultaneously supporting or lifting the main or trigger handle of the grinder causing the grinder blade to rotate evenly on the grinding surface and to hover in place while the other hand holds the side or assist handle to control the direction that the tool will move and to stabilize the head of the grinder for smooth and level operation.

While being a very useful tool, the handheld, right-angle grinder requires the user to work in close proximity to whatever dust and debris is generated by the tool, as well as in close proximity to the rotating blade of the tool. Furthermore, grinding on a floor or other low surface requires grinding on one's hands and knees or in a severely bent over position, both of which are very uncomfortable positions. The movement of the tool is furthermore limited in range to the length of the operator's arms, requiring frequent changes in position for a long cut or large surface. Such repositioning is very awkward and tiring when working on hands and knees or bent over.

There are single-purpose, walk-behind, prep machines in the marketplace today that may cost thousands of dollars to buy. These tools are generally limited to the single purpose they were designed for, as well as being very expensive. For example, walk behind concrete saws generally only perform cuts with vertical blades. Walk-behind floor grinders generally only perform horizontal grinding.

Extension handles systems have been proposed in order to operate handheld grinders in an upright position when working on a floor. As one example, U.S. Pat. Pub. No. 2014/0369019 A1 to Sabia discloses a power tool operating device including a handle shaft, a tool mounting shaft, a power tool mounting head with a bracket, including left and right bracket forks, a control handle with a comfort grip, and a wiring harness, including a female electrical plug and a momentary electrical switch, and a male electrical plug, whereby a user can operate a power tool at floor level while standing. Sabia teaches that the handle must not pivot or move independently from the power tool. Also disclosed is a power tool fastener which wraps tightly around the power tool and the power tool mounting head to further stabilize it. For reasons that will be explained in detail below, the operation of a grinder with such a tightly fixed extension handle is less than optimal.

U.S. Pat. Pub. No. 2008/0171499 A1 to Stoll recognizes difficulties with a fixed grinder position and discloses a rather complicated stand-up grinder caddy with adjustable handle, wheels, and levers and springs for adjusting the grinder tilt. The grinder apparently can only tilt on one axis, forward and backward, which is less than optimal.

Extension handles have also been applied to orbital sanders, as disclosed in U.S. Pat. Pub. No. 2018/0345442 A1 to Nix et al.

WO 2004/056536 A1 discloses a dust shroud with a removable segment.

What is needed is a simpler extension handle system that allows a right-angle grinder to be operated from a standing position just as smoothly and efficiently as if being handheld in the conventional way.

### SUMMARY OF THE INVENTION

The present invention is directed to systems and methods which provide for the operation of hand power tools such as right-angle grinders and orbital sanders, or provide an extension handle system for stand-up operation of angle grinders, orbital sanders, and other power tools.

In one embodiment the invention is an extension handle system for a handheld power tool with: a shaft with a first end opposite a second end; a fork assembly attached to the first end of the shaft; an assist handle attached to the shaft between the two ends; and a main handle attached to the second end; wherein the main handle has a cord guide and a cord lock. The main handle may include a power switch, a male electrical plug, and one or two female electrical receptacles. The power switch may be an on/off switch or a variable speed controller.

The cord guide and cord lock route the power cord of a grinder so that the cord span there between runs parallel to and spaced apart from a hand grip on the main handle. A user gripping the handle can pull on the cord span with fingers on the same hand to lift the handle of the grinder below. Thus, the main handle and assist handle give the operator the same degree of control of the grinder tilt as in handheld operation of the grinder.

A wire-lock pin may fasten the main handle onto the shaft and the wire retainer of the wire-lock pin may be the cord guide. A protrusion on the side of the main handle may match the shape of the wire loop on the wire retainer and hold it fast in place.

The fork assembly may have two transverse members, two parallel and spaced apart forks, one said fork projecting from each of the two transverse members; wherein the transverse members are adjustably fastened together and adapted to set the fork spacing to a predetermined value based on the width of the head of a grinder or other tool. Pivots may be adapted to pivotably attach the right-angle grinder between the two forks. Pivoting is necessary for the desired control of the grinder tilt.

The fork assembly may include a post projecting from one of the transverse members in the opposite direction from the forks, and the post may have a through hole that is aligned with a through hole near the first end of the shaft, and a pin passing through the through holes may attach the fork assembly to the shaft.

The shaft may be modular and storable in shorter lengths.

A number of inventive accessories may be included with the extension handle system or included in various embodiments of the invention. In some embodiments, a vertical grinder shroud may be mounted on a grinder for vertical cutting. The vertical shroud has a two-piece housing with an inner shell and an outer shell; and fasteners that hold the shells together; wherein the inner shell has an opening with a surrounding collar projecting from the inner shell, the collar adapted to fit around the arbor mount of a right-angle grinder and has set screws to hold it thereon. One or two vacuum hose bibs may be included on the shroud.

A skate assembly may support the extension system for cutting with the grinder in vertical blade orientation. The skate assembly includes one or more wheel skates having four in-line wheels spaced apart in a square or rectangular arrangement; a frame supported on and adjustably fastened to the one or more skates; a slide bracket pivotably attached to the frame with fasteners for mounting the extension handle system; and a pitch adjustment nob that sets a rest angle for the slide bracket. There may be sufficient space through the one wheel skate or between two wheel skates whereby, when a grinder has a vertical shroud mounted and the grinder is mounted in the fork assembly which is bolted to the slide pivot at a predetermined rest angle, and the shroud is set to ride at or near a floor surface, the space prevents interference between the shroud and wheel skates.

In other embodiments, a horizontal shroud is mountable on a grinder. This shroud has a shroud body with an opening in the middle; a collar with one or more set screws projecting upward around the opening; one or two vacuum hose ports projecting upward from the body; a plurality of stabilizer brackets attachable to the top of the body and projecting radially outward from the body; and a plurality of swivel caster wheels attachable to the stabilizer brackets. With connector brackets, multiple shrouds can be joined together for grinding a larger path.

In other embodiments, a sander shroud allows a palm sander to by used with the forks of the handle extension system. The sander shroud includes: a generally circular shroud body comprising two semicircular half bodies with an opening in the middle when assembled; lead-screw tab structures that pull the two semicircular half bodies together to form the assembled shroud body snuggly around a sander housing; and two fork attachment sites projecting upward from the top of the body. A vacuum hose bib may be included. Additional tabs and set screw may be included to more firmly attach the shroud to the sander.

Thus the invention is also directed to the fork assembly described above, the shrouds described above, the skate assembly described above, and a variable speed controller (“VSC”). The VSC has a housing with a rectangular-solid shape; a female electrical receptacle at one end of the housing; a male electrical outlet at the other end of the housing; an AC motor speed controller circuit board in the housing with a speed control shaft projecting from the top side of the housing and a speed control dial on the speed control shaft; and wiring in the housing connecting the female electrical receptacle and the male electrical outlet to the speed controller circuit board.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a perspective view of a conventional right-angle grinder;

FIG. 2 is a perspective view of an assembled embodiment of the invention in use with an angle grinder;

FIG. 3 is an exploded perspective view of the embodiment of FIG. 2;

FIG. 4 is a perspective view of the short fork assembly shown in FIG. 2;

FIG. 5 is an exploded perspective view of the short fork assembly of FIG. 4;

FIG. 6 is a front perspective view of the main handle shown in FIG. 2;

FIG. 7 is a rear perspective view of the main handle shown in FIG. 2;

FIG. 8 is a close-up, partial, front view of the base of the main handle shown in FIG. 2;

FIG. 9 is a partially fragmented illustration of a hand holding an embodiment of the invention;

FIG. 10 is a partially fragmented side view of an embodiment of the invention;

FIG. 11 is a perspective view of a conventional wire-lock pin useful in embodiments of the invention;

FIG. 12 is a partial, close-up view of a feature on the main handle;

FIG. 13 is a perspective view of the assist handle shown in FIG. 2;

FIG. 14 is a perspective view of a horizontal shroud for use with the invention;

FIG. 15 is a perspective view of the shroud of FIG. 14 assembled in an embodiment of the invention;

FIG. 16 is a perspective view of another use of the shroud of FIG. 14;

FIG. 17 is a side view of another horizontal shroud for use with the invention;

FIG. 18 is a top view of the shroud of FIG. 17;

FIG. 19 is a perspective view of a long fork assembly;

FIG. 20 is an exploded perspective view of the long fork assembly of FIG. 19;

FIG. 21 is a side view of an embodiment of the invention in vertical cutting mode;

FIG. 22 is a rear perspective view of a first vertical shroud;

FIG. 23 is a front perspective view of the shroud of FIG. 22;

FIG. 24 is an exploded perspective view of the shroud of FIG. 22;

FIG. 25 is a front perspective view of a second vertical shroud;

FIG. 26 is a perspective view of a skate assembly for use in an embodiment of the invention;

FIG. 27 is a perspective view of an element of the skate assembly of FIG. 26;

FIG. 28 is a perspective view an embodiment of the invention in vertical use;

FIG. 29 is a partial side view of another embodiment of the invention in vertical use;

FIG. 30 is an exploded perspective view of a sander shroud embodiment;

FIG. 31 is another exploded perspective view of the sander shroud of FIG. 30;

FIG. 32 is a partial view of a sander with sander shroud in use in an embodiment of the invention;

FIG. 33 is a front perspective view of an embodiment of a variable speed controller useful with embodiments of the invention;

FIG. 34 is a rear perspective view of the variable speed controller of FIG. 33;

FIG. 35 is a perspective view of an alternate embodiment of the main handle; and

FIG. 36 is a perspective view of an alternate embodiment of the assist handle.

### DETAILED DESCRIPTION

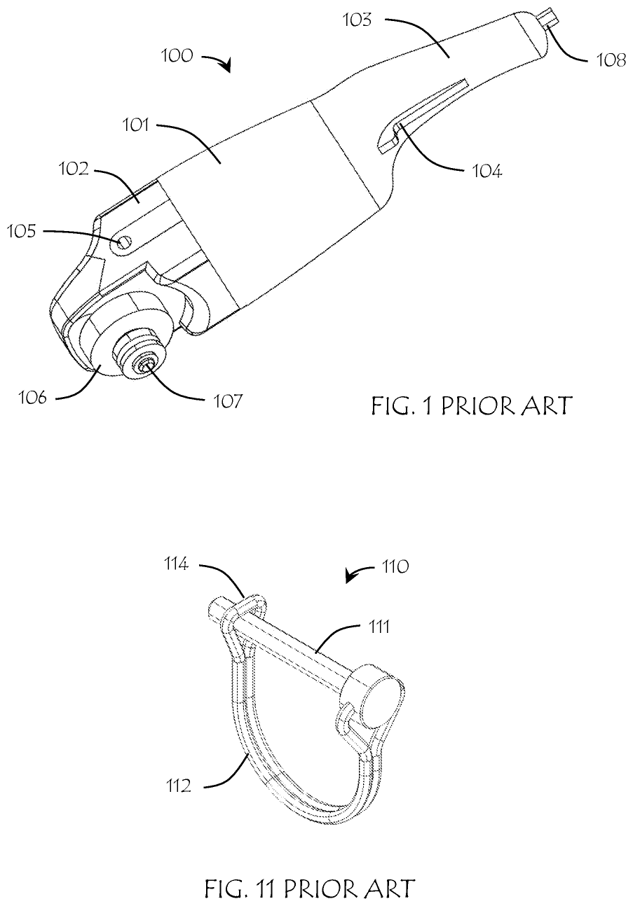

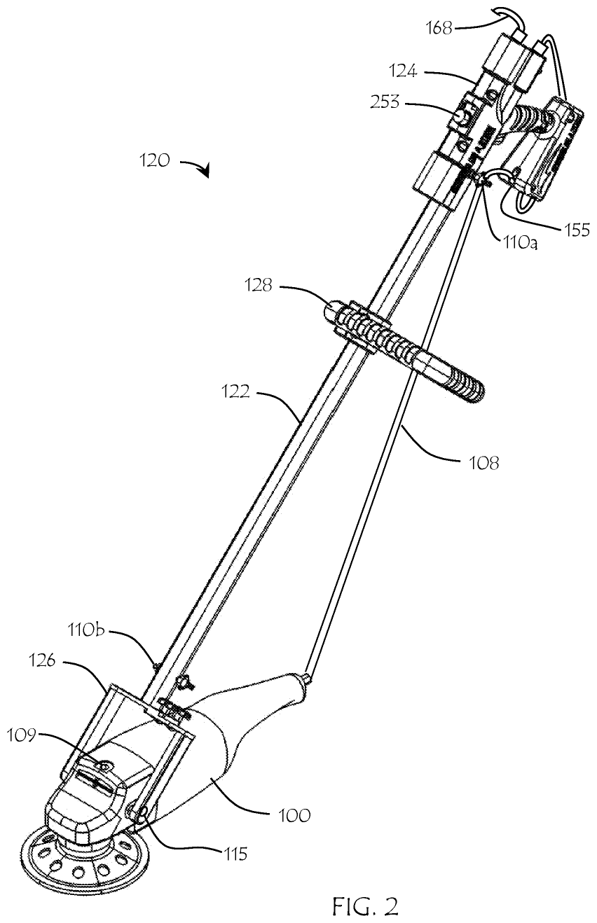

The main components of the inventive extension handle system are illustrated in one embodiment of the invention in FIG. 2 and FIG. 3. Extension handle system 120 includes shaft 122 with main handle 124 attached at the upper end of shaft 122, fork assembly 126 attached at the lower end of shaft 122, and assist handle 128 attached at an intermediate position onto shaft 122. As shown in FIG. 2, grinder 100 may be mounted between the two forks of fork assembly 126 using suitable bolts threaded into the grinder's left and right auxiliary mounting holes (see hole 105 in FIG. 1) forming pivot(s) 115. The fork assembly 126 and main handle 124 are attached to shaft 122 using wire-lock pins 110a and 110b inserted through suitably sized and aligned holes 125 and 127, respectively.

Grinder 100 may preferably be pivotably attached to the forks of fork assembly 126. Although grinder 100 could instead be bolted to the forks so that it is tightly fixed and not able to pivot or swivel, for the desired operability of a grinder in horizontal position on a horizontal surface it is preferred that the attachment allow the grinder to pivot or swivel freely between the forks. The pivot(s) 115 could be fixed to the forks and pivot within the grinder's holes 105. The pivot(s) 115 could be bolts extending through holes in the forks and threaded into holes 105 with sufficient length or spacers to allow the bolts to pivot within the holes 105.

Leveling and tilting grinder 100 relies on power cord 108. The retainer 112 of upper wire-lock 110a also functions as a cord guide allowing free movement of power cord 108. After passing cord 108 through retainer 112, the cord is locked into cord lock channel 155 in the base of main handle 124 and finally plugged into a power receptable in main handle 124. A user can then pull on the cord span between the cord guide and the cord lock to raise the handle of the grinder. This unique mode of operation will be explained in more detail below.

The shaft 122 may be a solid or hollow shaft, pole, tube, or pipe of sufficient strength to transfer or elevate the operation of the grinder up to the user. The shaft could be made of any suitable material or product such as metal or composite for pipe, shaft or pole. The shaft is preferably hollow for light weight and for insertion of and attachment to the fork assembly in a way which will be described in more detail below. Other fork-assembly, attachment methods are possible and would be used if the shaft is solid. The shaft could be made telescoping or modular for adjusting to a user's preferred height or for easier storage.

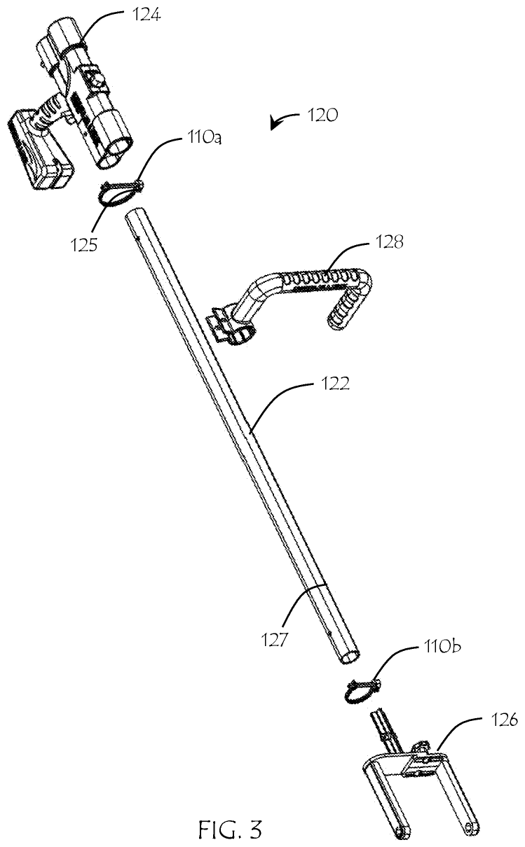

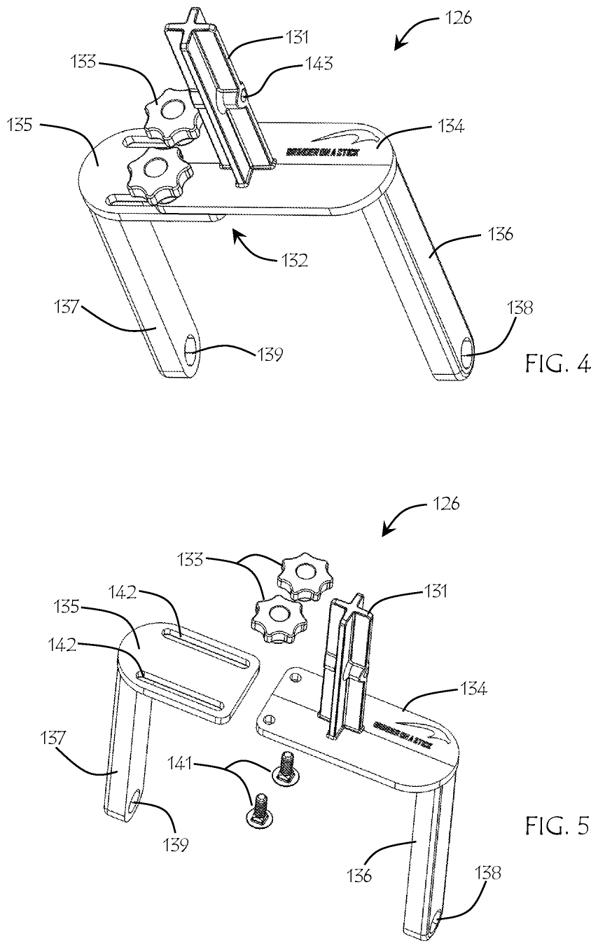

Fork assembly 126 is shown in more detail in FIG. 4 and FIG. 5. The fork assembly 126 may be called a “short” fork assembly since the grinder must reside at an angle to the forks. A “long” fork assembly will be described later, in which the grinder may reside parallel to the forks. The short fork assembly is useful for normal, horizontal operation of the grinder with the extension handle system. Fork assembly 126 includes two, spaced-apart, parallel forks 136 and 137 mounted to one side of a plate or transverse frame 132. Mounted to the other side of frame 132 is stem or post 131 which is adapted to attach to shaft 122. In the embodiment shown, frame 132 has two frame portions 134 and 135 which overlap and are fastened together by carriage bolts 141 and knobs 133. Two parallel slots 142 in one plate 135 and two holes in other plate 134 enable the plates to be adjusted, thus adjusting the spacing between the two forks. The fork assembly 126 may therefore fit the head of most any size of right-angle grinder. Adjustable forks also allow either fixed mounting of a grinder or pivotable capability depending on the application. For a dedicated application, one may use a one-piece frame or plate without adjustability, with the forks set at a predetermined width.

The two-piece adjustable fork system 126 can mount a grinder, a sander, or other tools to the shaft 122 to complete the extension handle system. In other variations, the forks may have two different size of mounting holes at the end of the forks to accommodate different sizes of bolts or pivots for various sizes of grinders, sanders, shrouds or other tools or accessories.

The locking stem or post 131 in this embodiment is meant to to be received inside shaft 122 and locked into place by wire-lock pin 110b through shaft hole 127 and through hole 143 on stem 131. Handle system 120 is shown set up for horizontal surface use, i.e., the grinder mounts to the forks in its normal horizontal position. In other embodiments, the fork stem could be tubing sized to fit into or around the shaft. Optionally, the locking features may provide for other positions, by providing either additional holes in shaft 122 or on stem 131, e.g., holes aligned for vertically oriented forks in which the grinder would mount for sideways or vertical-blade use (90 degrees from the horizontal position). The ability to use a tool in either horizontal or vertical position makes this handle system extremely versatile. The system can function with a wide range of tools useful for concrete prepping, polishing, cutting, demolition, chopping, resurfacing, abrading, sanding, scuffing, stripping, and the like, i.e., the full range of functions of grinders and sanders. In each case, the handle system may enable the user to operate any number of tools in a standup, walk-behind operation or application.

It may be noted that the bolts used in the fork assembly and handle system of any of the tools described herein may advantageously be vibration-proof bolts, nuts, and/or knobs to help prevent loosening during extended operation.

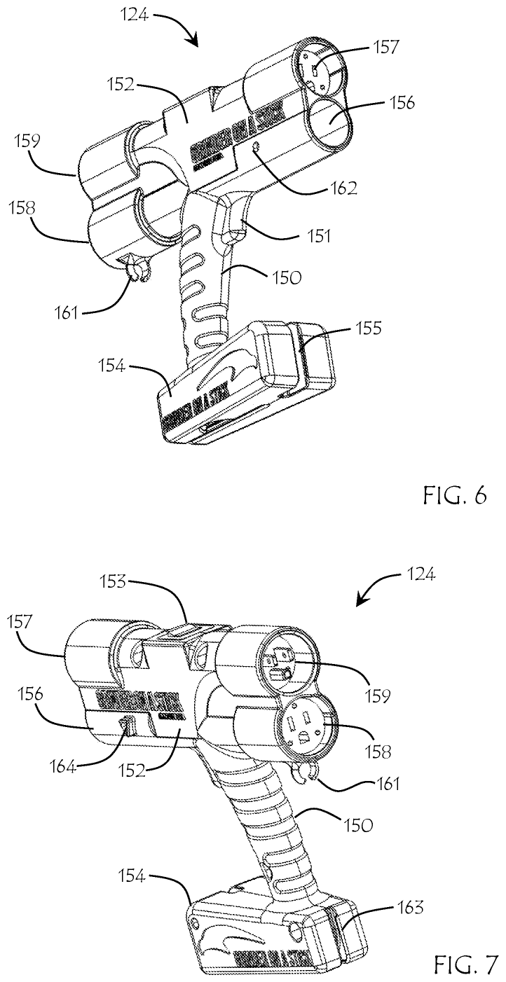

Main handle 124 is shown in more detail in FIGS. 6-12. Main handle 124 includes a number of uniquely designed features for optimal operation of a grinder on the end of the extension handle system. The major parts of main handle 124 include the main hand grip 150, base 154 attached at the lower end of grip 150, and electrical housing 152 and shaft receptable 156 attached at the upper end of grip 150. Hand grip 150 may include finger grip 151.

Base 154 of main handle 124 includes cord-lock channel 155. Base 154 may include other features such as tool receptacle 163 for mounting an Allen wrench or other small tool.

Shaft receptacle 156 is adapted to receive and hold the upper end of shaft 122. Shaft 122 in this embodiment is meant to to be received inside receptacle 156 and secured into place by wire-lock pin 110a when inserted through hole 162 on main handle 124 and through shaft hole 125. The pin may emerge from hole 162 on the opposite side of the main handle. The exit hole may include a protrusion shaped to receive and hold the loop on the end of the retainer wire 112 of the wire-lock pin 110a. The wire mount 164 is the same shape as the wire loop 114 on the end of the retainer wire 112 and prevents the wire from lifting up and pinching the cord or impeding the easy sliding of the cord through the retainer wire 112. In the embodiment shown, the protrusion is triangular wire mount 164 on which triangular wire end 114 fits, as shown in FIG. 12.

Wire-lock pin 110a functions as a cord guide. FIG. 2 and FIG. 10 particularly show power cord 108 of grinder 100 routed through cord guide 115, which in this case is provided by wire-lock pin 110a. Alternatives to the wire lock pin are possible, such as bolts, other pin styles, and the like. Likewise, other cord guide designs are possible, such as rings, eyelets, loops, clips, pulleys, and the like. One could attach a lift wire, cable, or rope to the grinder handle and route it through the cord guide instead of using the power cord. The operational function to be described below is the important aspect of the cord guide.

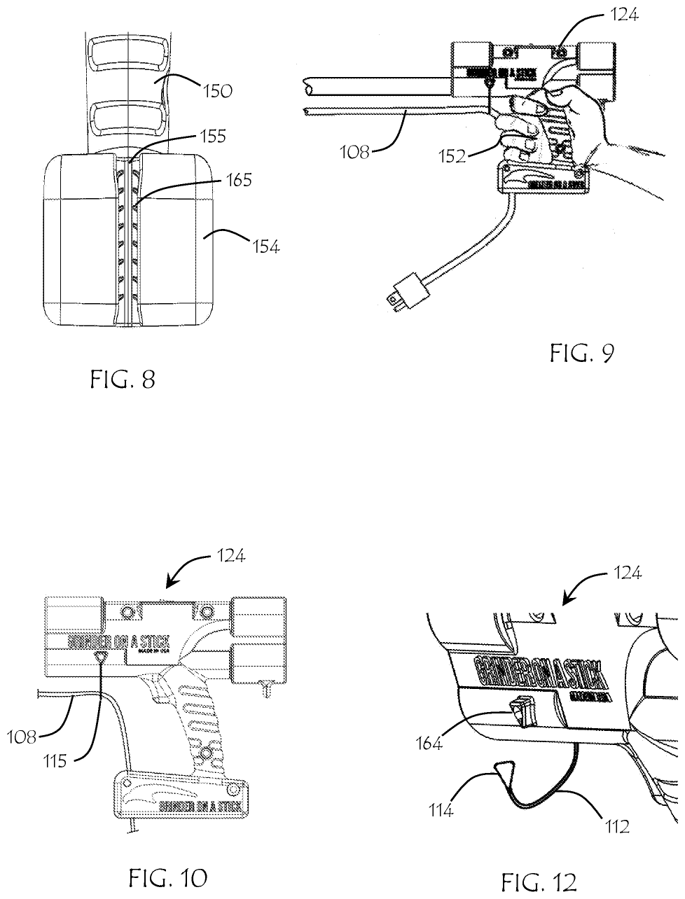

After passing through cord guide 115, power cord 108 is routed into cord-lock channel 155 as shown in FIG. 10. Channel 155 may use any suitable mechanism to lock in the power cord, such as a clamping mechanism, one or more set screws or bolts, or clips, or the like. A preferred cord-lock mechanism is a plurality of gripping fingers on either or both sides of channel 155 as illustrated by cord-gripping fingers or ribs 165 in FIG. 8. The locking ribs may be deflected downward to help prevent the grinder's cord from pulling up or out. The channel permits the cord to be easily inserted, then pulled downward to the desired position while restricting upward movement during operation. As the cord is pulled on during operation, the downward-turned ribs tighten their grip to prevent the cord from pulling up or out. This method of operation is illustrated in FIG. 9 and will be described in more detail later.

Electrical housing 152 includes a number of features, including a power switch, which could be simply on/off switch 153 shown in FIG. 7, or a variable speed controller indicated by dial 253 in FIG. 2. The power switch is firstly internally wired to male electrical outlet 159 for connecting an extension cord 168 to power the tool. The power switch is then internally wire to one or more female electrical receptacles 157, 158 into which the grinder (or other tool) power cord 108 may be plugged in order to power the grinder. In the embodiment shown, there are two female receptacles 157, 158 on opposite ends of electrical housing 152 for convenience. Of course, additional outlets and/or switches could be provided if needed. For example, the finger grip 151 could be replaced with a finger trigger for momentary power or for variable speed control. The variable speed controller is preferably chosen for speed reduction of AC (alternating current) motors running on the local voltage and frequency, for compatibility with the grinder or sander or other tool used.

The variable speed controller provides variable speed control which may be useful for certain applications such as drywall sanding. If the variable speed control is wired to both the female outlets on the main handle, then only one outlet should be used at a time.

Other features may be included with main handle 124. Extension cord clip 161 may be included to help manage an extension cord, for example by helping to prevent the extension cord from pulling out of the outlet during operation. Tool clip 163 may be included to store a wrench, screw driver, Allen wrench or other small tool. By way of example, if the cord channel were to use an Allen bolt to lock the grinder's cord into the channel, the Allen wrench would always be available if stored on such a tool clip.

Main handle power switch may be used as follows. There is normally a locking mechanism built into a grinder to lock the grinder power switch in an “on” position for operation. The user of the invention can turn off the power switch on the main handle, lock the grinder power switch in the “on” position, and plug the grinder in to the tool outlet on the back lower receptacle. Then when the user wants to begin grinding, they simply turn on the power switch on the main handle and go.

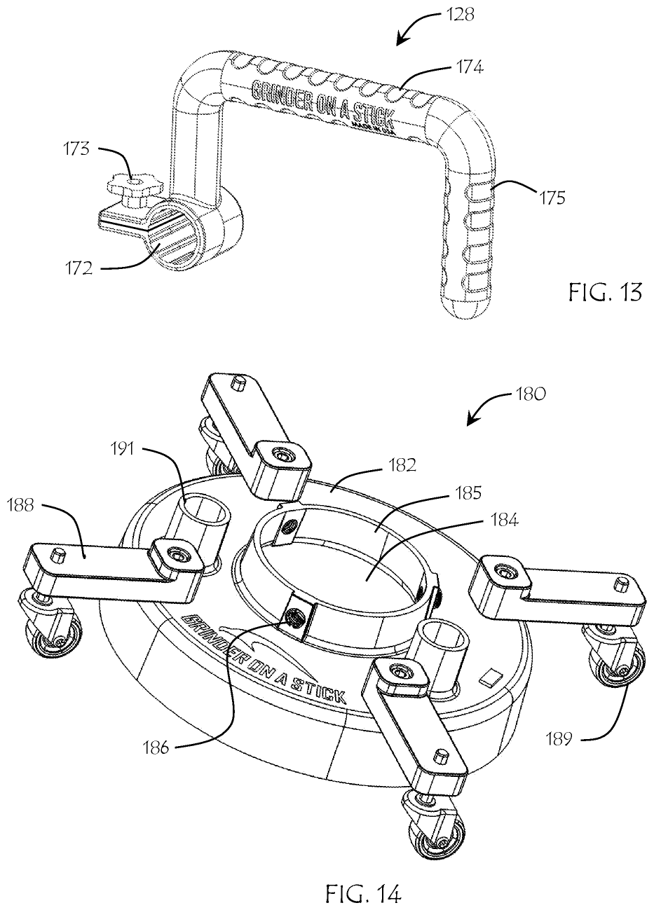

Assist handle 128 is shown in one embodiment in FIG. 13. Although any desired handle shape may be used, the shape shown has some advantages. Assist handle 128 may include a clamping portion 172, a horizontal gripping portion 174, and a vertical gripping portion 175. The clamping portion 172 makes for easy and adjustable attachment to shaft 122. The gripping portions may thus be located at any convenient position on the shaft and at any desired orientation, whether for left-handed or right-handed use. Any suitable material(s) may be used for the handle, such as metal or composite material, or with a soft touch gripping surface. Any desired fastener may be used, including for example, knob and bolt combination 173.

The assist handle allows the user to control the direction that the grinder moves, both forward or backward and from side to side. The assist handle's design and adjustability makes it great for reducing fatigue and increasing safety during operation.

Horizontal operation of the inventive main handle system in a standing position may now be described with respect to a grinder. The handles provide excellent and ergonomic control over the grinder, utilizing the cord as a blade level lift system, and with easy access to the power switch located on the main handle. With this system the user is now out of the dust and debris associated with conventional grinding, giving a very real health and safety benefit. The user is now working “over” his work instead of “in” his work and with a much further reach than possible with conventional grinding which is limited to the length of the user's arms.

The advantages of the invention may be understood by considering the normal operation of the right-angle grinder, in particular when grinding a floor or other low horizontal surface. In conventional horizontal grinding the user typically drops to one knee as he takes hold of the main trigger handle while simultaneously taking hold of the side assist handle. The user lays the blade or cutter flat on the surface by lifting the main handle up to level it and then turns the grinder on. The user then begins to push the grinder in and out and back and forth to grind the intended surface.

If the user turns on the grinder without leveling the blade first, the pitched or tilted blade will quickly and rapidly spin the grinder out of the user's control due to the centrifugal forces, pivotal pull, and rotational thrust. Therefore, the blade must be level on the surface before power can be applied. Furthermore, if the blade is not sitting level on the surface during operation, similar control issues may occur. During operation, the skilled user will apply slight tilts to cause the grinder to move about in a desired pattern, i.e., to steer the grinder.

With prior extension handle designs such as described in the background (see e.g., U.S. Pat. Pub. No. 2014/0369019 A1), blade leveling and blade control for steering both require adjusting the position of the entire assembly because the grinder is rigidly attached to the handle, i.e., in a fixed position on the handle. If the blade finds itself in a pitched or tilted position, either forward or backward of level, the blade will react erratically once powered until a level hovering position is found. Any slight variance of the blade or cutter being off center will cause the rotating blade to spin off in that tilted direction. This can be very difficult to manage during operation. Constantly searching for this neutral, level position can be exhausting and frustrating for the user and the grinder may bounce erratically at the other end of the shaft or handle. After much experimentation with such rigidly attached handles, the inventor concluded that a better system was needed.

In the present invention, the grinder is pivotable within the attachment forks so the user can simulate the same handle-lifting motion as during conventional handheld operation. The grinder's power cord may function as an extension of the main grip and provide the means for the operator to adjust the forward pitch of the blade with minor movements of his fingers. One suitable grip method is illustrated in FIG. 9, where the thumb and pointer finger grip the handle grip tightly while the remaining three fingers 152 loosely grip the power cord 108. With the power cord locked in the cord lock channel with suitable tension on the cord, tightening or loosening the grip of fingers 152 results in lifting or lowering the grinder's main handle below. Surprisingly little movement is necessary to cause the grinder to hover on the work surface, even at very high rpm. The user can keep the entire handle system at a relatively constant angle while using the cord-based handle lifting system. Furthermore, the assist handle of the invention provides the same control as the conventional assist handle during handheld operation, i.e., for sideways pitch. Thus, the invention allows the user to level and steer the grinder on the extension handle with as much ease as in handheld operation, but with greater reach. With this tool, the user can easily maintain a 20-pound, 8500-rpm grinder in a hovering position and subtly guide it over a surface.

U.S. Pat. Pub. No. 2014/0369019 A1 also teaches that a rigidly attached grinder is necessary and essential to ensure that pressure applied to the handle be transmitted down to the face of the tool. Surprisingly, the inventor has found that the present pivoting arrangement with cord lifting control still allows sufficient pressure transmission for most jobs. If more pressure is needed, many grinders have a threaded hole (see threaded hole 109 in FIG. 2) located on top of the grinder head that can be used to mount additional weights onto the grinder. Additional hole 109 on top of the grinder is intended for mounting the conventional assist handle for handheld use in the vertical blade position.

Additional Accessories:

With the inventive handle system as the starting point, one can create all kinds of preparation machines to service industries and trades where abrasives are used and at a fraction of the cost of dedicated walk-behind prep machines, but just as effective. A number of inventive accessories and use in the vertical or cutting position are described next.

Horizontal Shroud:

FIGS. 14-16 show an embodiment of a horizontal shroud for wet or dry use with a grinder mounted in an embodiment of the extension handle system. In FIG. 14, horizontal shroud 180 includes shroud body 182 shaped like an inverted bowl and sized to fit over typical blade or grinding wheel sizes to be used with grinder 100. The body includes circular opening 184 with upward-projecting, cylindrical flange or mounting collar 185. Opening 184 accomodates the grinder's arbor or spindle 107 and mounted blades or wheels. The wheel height may be adjustable. Mounting collar 185 fits over arbor mount 106 and is secured appropriately, in this case with three set screws 186. A plurality of stabilizer brackets 188 may be attached to the body. FIG. 14 shows four such brackets 188 bolted to the top of the body 182. These brackets may be used to mount adjustable casters 189. The body 182 may include one or more dust port or vacuum bib 191 to which a vacuum hose may be attached for dust collection during use. A water spicket attachment which allows for wet grinding with diamond cups and blades can also be provided on the shroud. A 7-inch nominal body diameter is a convenient size for mounting all kinds of 7-inch or smaller blades on the grinder arbor. Other sizes can be made by scaling.

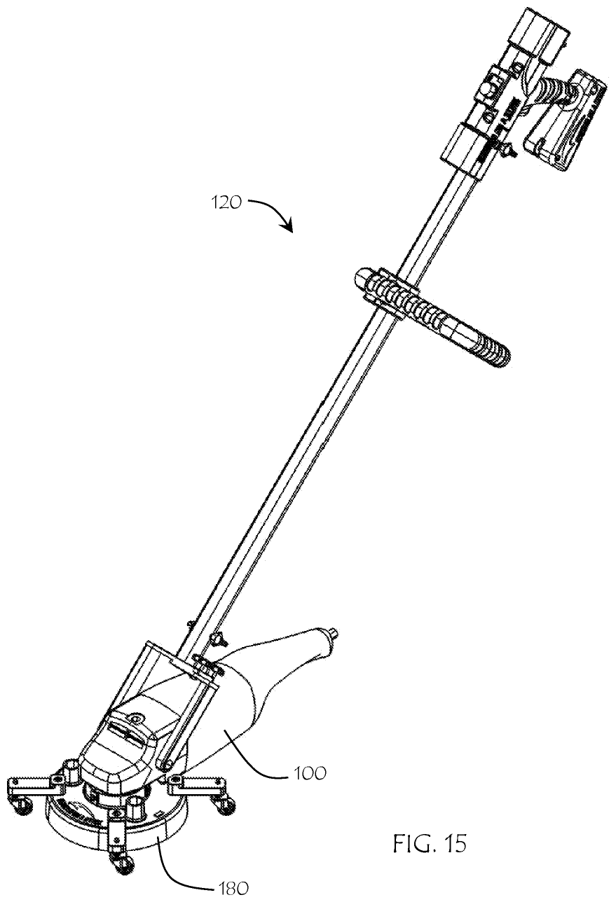

FIG. 15 shows horizontal shroud 180 mounted on grinder 100 which is mounted on extension handle system 120.

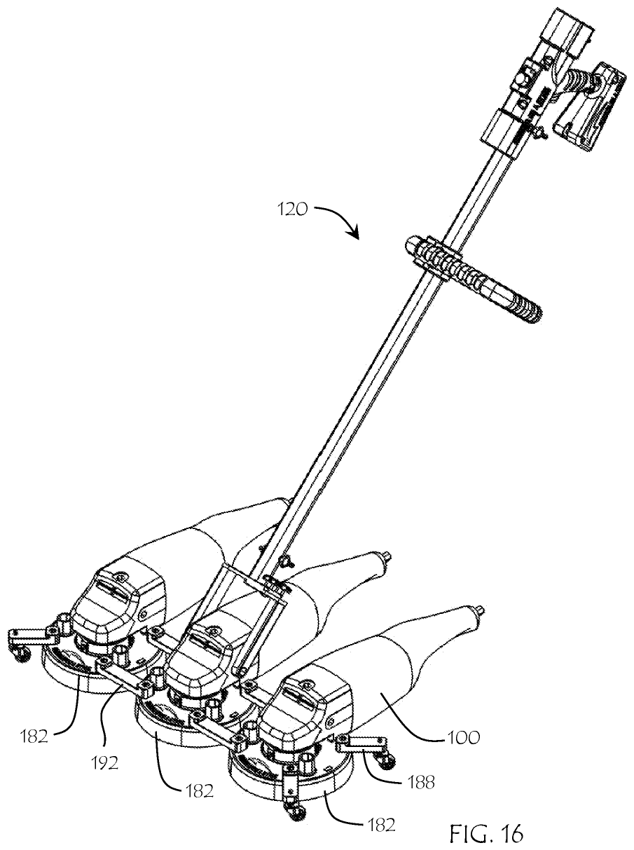

FIG. 16 shows multi-unit operation with horizontal shrouds. The horizontal shroud can be used to bracket multiple grinders together in a side by side fashion to increase the preparation surface area. In FIG. 16, each of three grinders 100 has one shroud body 182 mounted thereon. The three bodies 182 are interconnected using adjustable swivel connector brackets 192, which fasten onto the bodies just like the stabilizer brackets do. The two end grinder units each have two stabilizer brackets attached with corresponding casters thereon. Thus, the multi-unit assembly still has four caster wheels at the four corners for stability. A single extension handle system 120 is attached to the middle grinder and used to drive the tools.

The adjustable caster wheels are on the shroud to make the shroud and blades hover over the surface being ground or sanded. These caster wheels move up and down which allows the user to adapt to the height of every type of grinder, backer pad, diamond cup, silicon carbide disc, sanding disc and other types of abrasives available on the market today. The casters brackets are designed to swing out for stabilization so the grinder can glide over the surface being ground evenly and without gouging. The adjustable caster wheels suspend the blades or cups at the same level so to have a smooth profiled surface. The blades just coast over the surface being sanded or ground similar to how a wood planer works to make 2×4's and other boards that need to be even and smooth.

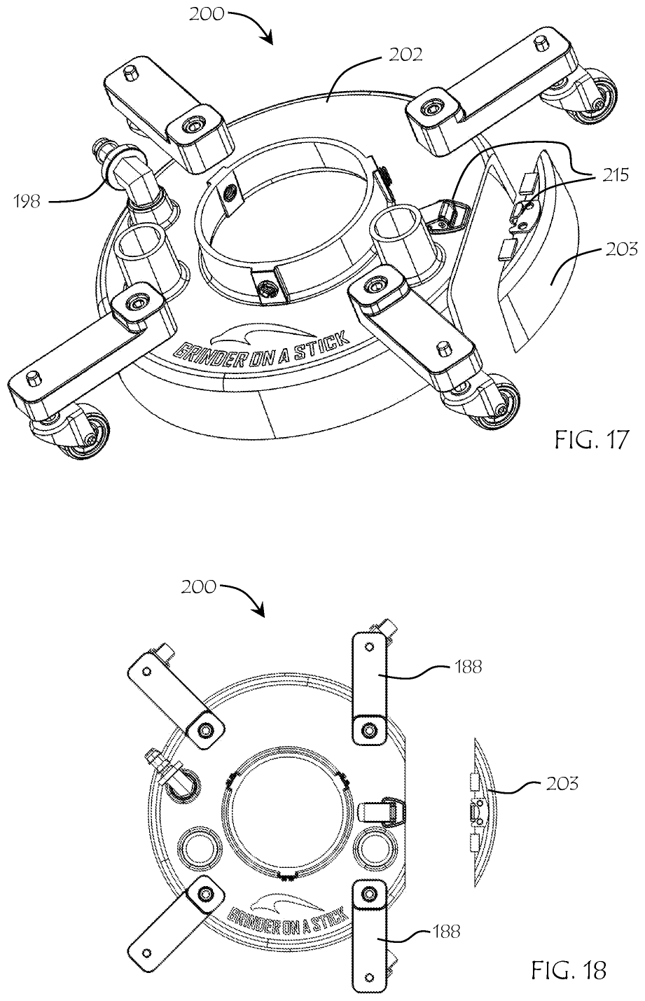

In another horizontal shroud embodiment, shown in FIG. 17 and FIG. 18, the shroud body may include a removable side guard or cut away portion which permits a blade to protrude partially. In FIGS. 17 and 18, horizontal shroud 200 includes removable side guard 203 which can also remain assembled on main body portion 202, making a two-piece shroud body. Cover latch 215 is an example of a suitable attachment mechanism for the two-pieces. As in the previous example, shroud 200 may include mounting collar 205 with set screws 206 and circular opening 204. Caster wheels 209 may swivel and be adjustably mounted on adjustable swivel stabilizer brackets 208. One or more vacuum hose bibs 211 may be included. In all the shrouds disclosed herein, a water injection port, bib or spigot may be attached to the housing. Shroud 200 has water hose bib 198. FIG. 18 illustrates how one or more stabilizer brackets 188 may be rotated or adjusted. In this case, brackets 188 are rotated to be parallel to straight edge where cover 203 was removed. This allows shroud 200 to be used as closely as needed to a wall or baseboard.

Conventional shrouds can gouge and tear up the surface because there is nothing to stop the blades from digging in or gouging the surface. This is especially true on rough and/or soft concrete. The inventive shrouds may have adjustable rubber skirting that allows the user to adjust the skirting up or down to accommodate many different types of blades. The adjustable rubber skirting may adjust to work with any of the many different grinders and blades. It may have a toggle latch so that it can be adjusted to keep the dust and water inside the shroud by loosening toggle latch, adjusting and retightening the latch. Or the rubber skirt may be an endless rubber band which can be stretched around the shroud perimeter and adjusted at will.

Thus, the tool system may be used to make horizontal cuts or grind at or near the base of wall, or in a baseboard, for example. The shroud may be made of aluminum alloy or other metal or hard plastics for greater longevity. Each shroud embodiment is an enclosed design that separates the grinder motor from coming into contact with the water or dust produced inside the shroud. The shroud attaches to the arbor mount which is a sealed unit that is outside of the grinder's motor casing. Having connected the shroud to the arbor mount, water and dust cannot reach the motor of the grinder.

The removable baseboard cover on the horizontal shrouds improves on the conventional flip up cover which never gets completely out of the way in a conventional grinder because it is always attached to the shroud even though bent upwards. The inventive baseboard cover is removable so it is completely out of the way. The other issue with conventional flip-up baseboard covers is they often break off after some use.

Long fork system for vertical cutting:

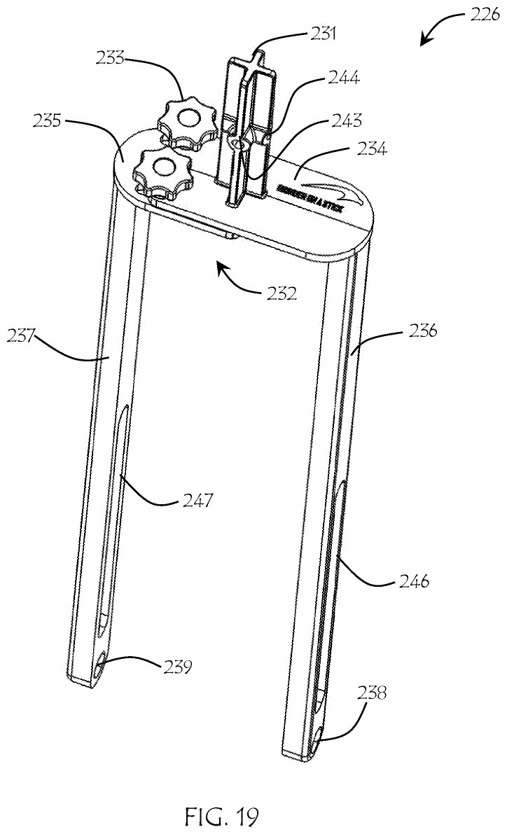

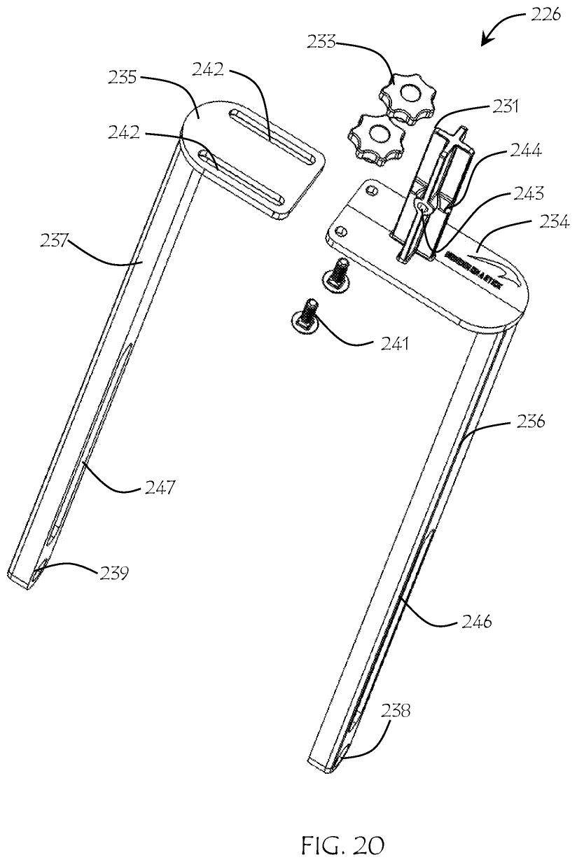

As mentioned above, the short fork system does not permit the grinder to be mounted fully parallel to the forks. A long fork system which does allow parallel mounting of the grinder, and vertical orientation for floor cutting, is the next accessory presented. FIGS. 19 and 20 show an embodiment of a long fork in assembled and exploded views, respectively.

Fork assembly 226 includes two, spaced-apart, parallel forks 236 and 237 mounted to one side of a plate or transverse frame 232. Mounted to the other side of frame 232 is stem or post 231 which is adapted to attach to shaft 222. In the embodiment shown, frame 232 has two frame portions 234 and 235 which overlap and are fastened together by carriage bolts 241 and knobs 233. Two parallel slots 242 in one plate 235 and two holes in other plate 234 enable the plates to be adjusted, thus adjusting the spacing between the two forks. The forks 236 and 237 are long enough that fork assembly 226 may fit around the handle and body of most any size of right-angle grinder. The adjustable-width forks also fit any size grinder head and allow either fixed mounting of a grinder or pivotable capability depending on the application. For vertical cutting, fixed mounting is preferred. For a dedicated application, one may use a one-piece frame or plate without adjustable width.

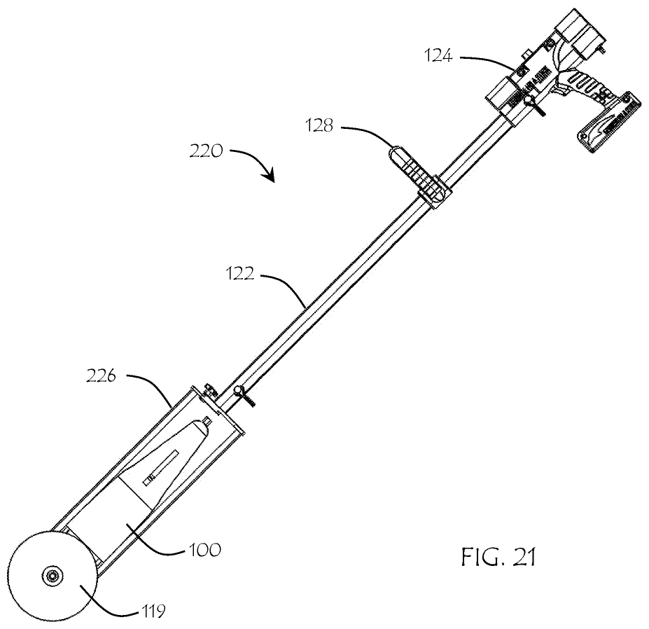

The locking stem or post 231 in this embodiment is meant to to be received inside shaft 122 and locked into place by wire-lock pin 110b through shaft hole 127 and through hole 243 or 244 on stem 231. Holes 243 and 244 are at right angles to each other, one for horizontal grinding and one for vertical cutting. In FIG. 21, handle system 220 includes shaft 122, main handle 124, assist handle 128, and long fork assembly 226, all assembled and set up for vertical cutting, i.e., grinder 100 is mounted to the forks with vertical cutting blade 119 in position. Forks 236 and 237 each have a long, vertical mounting slot 246 and 247, respectively, cut sideways through the fork and running length-wise above and separate from mounting holes 238 and 239. These slots facilitate mounting the long fork assembly on a skate assembly for vertical cutting, which will be explained in more detail below. The ability to use a tool in either horizontal or vertical position makes this handle system extremely versatile. The system can function with a wide range of tools useful for concrete prepping, polishing, cutting, demolition, chopping, resurfacing, abrading, sanding, scuffing, stripping, and the like, i.e., the full range of functions of grinders and sanders. In each case, the handle system may enable the user to operate any number of tools in a standup, walk-behind operation or application.

Again, it may be noted that the bolts used in the fork assembly and handle system of any tools may advantageously be vibration-proof bolts, nuts, and/or knobs to help prevent loosening during extended operation.

Shrouds for use in vertical cutting operations:

Embodiments of the invention include one or more vertical shrouds sized to accommodate all inverted blades including thin, crack chaser blades, demo blades and concrete cutting blades. Shrouds are advisable especially in vertical cutting mode to protect users or observers from the blade and from debris. For a safe and secure, heavy-duty, mounting system, the shroud is preferably of metal with steel setting bolts and inserts to hold the shrouds to the arbor mount of the grinder. The shrouds may be scaled to any desired size, but for practical purposes, a 7″ diameter and a 12″ diamater (nominal) shroud can accommodate any tool up to 12 inches in diameter.

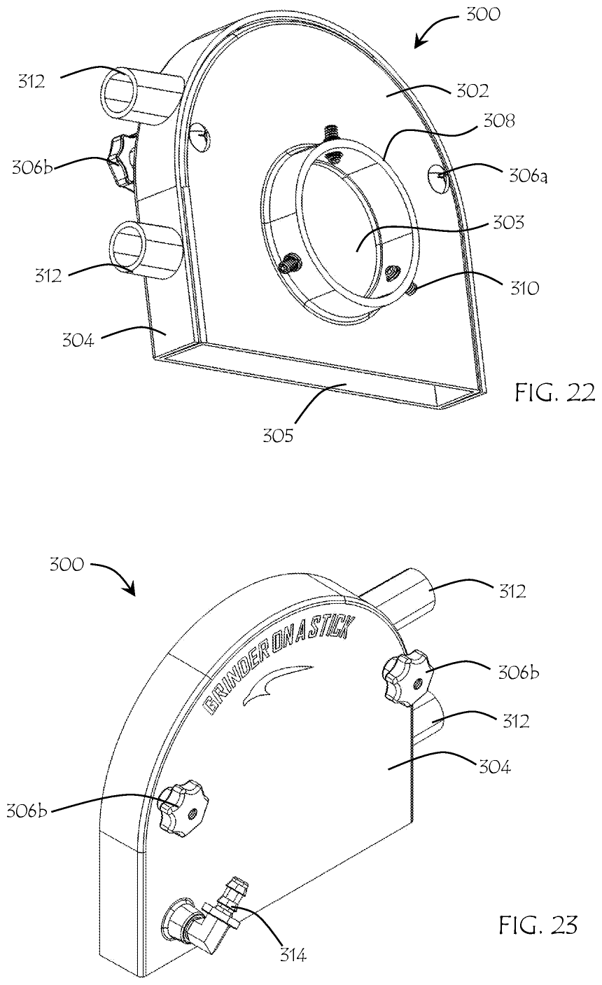

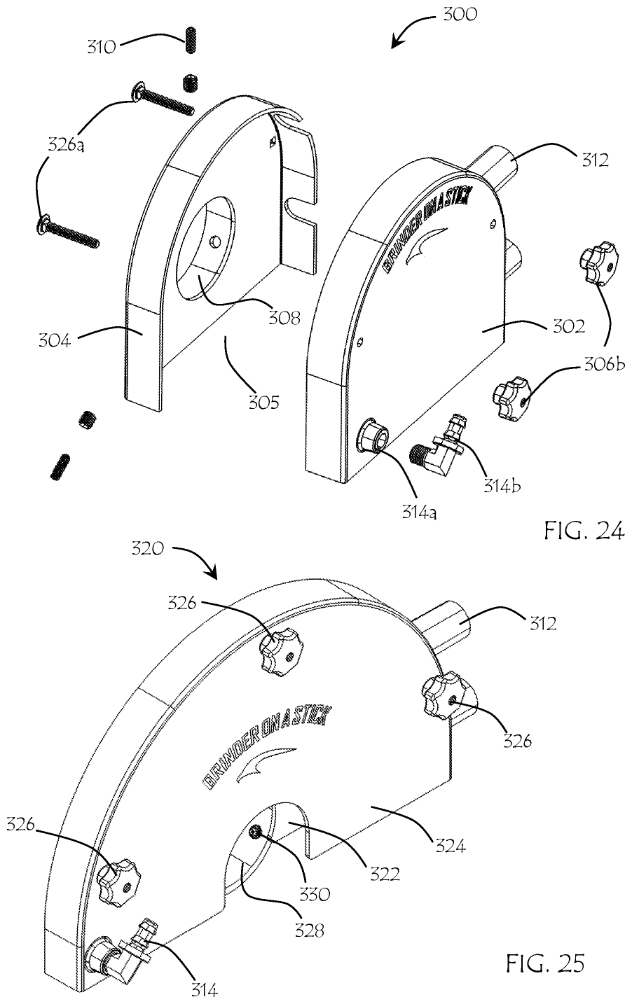

FIGS. 22-24 show a nominal seven-inch (7″) vertical shroud according to an embodiment of the invention. Seven-inch shroud 300 has two half shells, inner shell 302 closest to the grinder and outer shell 304, which nest together to house a circular saw blade. The assembly has an open bottom 305 through which a saw blade can protrude. Inner shell 302 has an opening 303 for the grinder's spindle to pass through and a circular flange or collar 308 sized to fit over the grinder's arbor mount. Set screws 310 in collar 308 tighten against the arbor mount to secure the inner shell of the shroud onto the grinder. Three set screws may be used. Fasteners 306 in the form of carriage bolts 306a and threaded knobs 306b hold the outer shell 302 and inner shell 304 together. Two or more fasteners may be used. The shroud may include one or more hose bibs for vacuum hose attachment. In the embodiment shown vacuum hose bibs 312 are mounted on outer shell 304, on a rear surface and projecting rearward. Other orientations are possible. A preferred configuration is two one-inch vacuum hose bibs oriented as shown, which are found to provide very good air flow and use light weight vacuum hoses.

The shroud may include a water hose bib. Shroud 300 includes water bib 314, which is shown as a combination of a bulkhead fitting 314a attached to the outer shell 304 and an elbow fitting 314b that threads into the bulkhead fitting and has a hose barb for connecting a water hose. The water hose fitting 314 is located on the side of the outer shell 302 of the shroud 300 and near the ground and near the front. This location is preferred for injecting water to the cutting blade and work surface. Other fittings and/or mounting locations that acomplish the same purpose may be used instead. The shroud 300 may be considered a closed shroud suitable for wet applications to contain the sludge generated in such operations.

FIG. 25 shows a nominal twelve-inch (12″) vertical shroud 320. The design is similar to the 7″ shroud, but it can house blades from 4.5″ to 12″ in diameter. It can work with many sizes and types of blades for many construction applications. Twelve-inch shroud 320 also has a two-piece shell design with inner shell 322 closest to grinder and outer shell 324. The assembly has an open bottom through which a saw blade can protrude. Inner shell 322 has an opening for the grinder's spindle to pass through and a circular flange or collar 328 sized to fit over the grinder's arbor mount. Set screws 330 in collar 328 tighten against the grinder's arbor mount to secure the inner shell of the shroud onto the grinder. Three set screws may be used. Fasteners 326 hold the outer shell 324 and inner shell 322 together. Two or three or more fasterners 326 may be used. The shroud may include one or more hose bibs 312 for vacuum hose attachment. vacuum hose bibs 312 and water injection bib 314 are mounted similarly to the seven-inch shroud above. Other orientations or locations are possible.

The shrouds may have a rubber skirt (e.g., an endless rubber band) to apply aroung the bottom opening to help keep the water contained during wet cuts and the dust contained in dry cuts. Again, the bolts and nuts and set screws used may be self locking types to prevent loosening during use.

Skate Assembly:

To safely operate a full-size right-angle grinder of about 20 pounds spinning at 8500 to 10,000 rpm's in an inverted position (i.e., vertical blade) on the end of shaft would greatly benefit from a substantial mounting frame to support the weight and the rotational thrust of the blades while maintaining smooth, straight and accurate cuts. In traditional inverted or vertical cuts the user holds onto the main handle and assist handle of the grinder, bends over. and makes the cuts about two feet at a time, depending on the length of the user's arms. Because of the weight of larger grinders like a 7″ grinder, the traditional user typically will prefer a smaller 4.5″ grinder even though it is not nearly as efficient as a 7″ grinder. Operating a grinder in a hunched over position drastically reduces the speed of which the task at hand can be performed and is extremely taxing on the body and the lungs. The invention of a mount or skate accessory makes the extension handle system safe and efficient for operating a grinder on a floor in a vertical, cutting position. The skate assembly allows the inverted grinder to float smoothly along on wheels. One can follow a chalk line or place the skate up to a piece of siding or other straight edge and roll the skates along the edge for a perfectly straight.

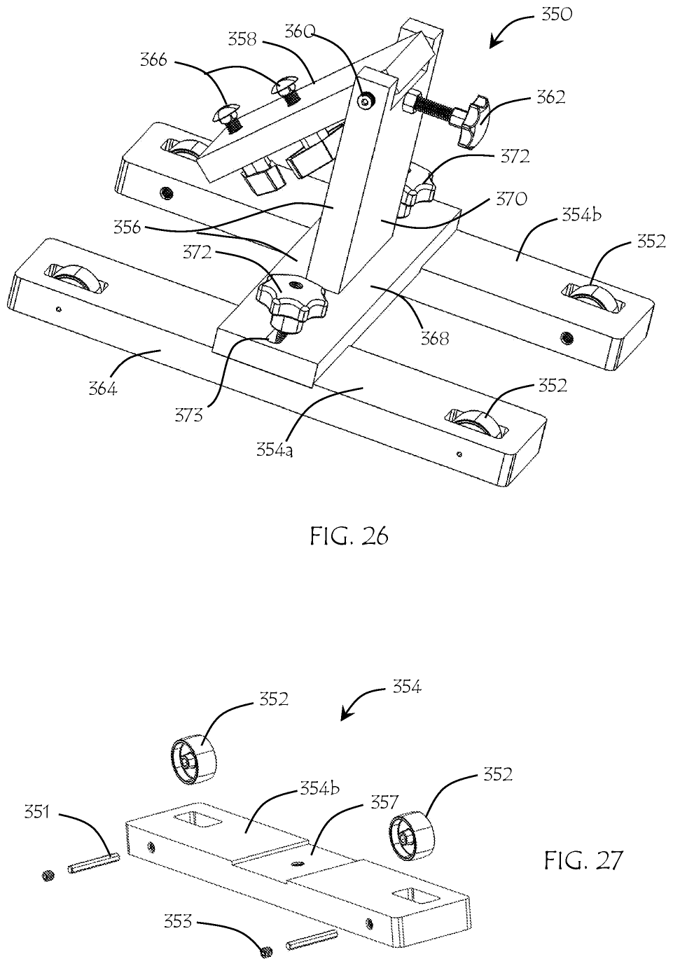

FIGS. 26-29 show an embodiment of the inventive skate assembly and ways of using it. In FIG. 26, skate assembly 350 includes four wheels 352 mounted to roll in the same direction in one or more wheel plates or skates 354 (see left skate 354a and right skate 354b in FIG. 26). Four in-line wheels gives the skate assembly excellent stability, but other numbers of wheels may be possible. A single large plate could mount all four wheels provided there is a cutaway or other space allowance for the blade and shroud. The skates 354 support a frame 356 which in turn supports a slide bracket 358 on which a long fork assembly may be mounted in a vertical-grinding position. Slide bracket 358 is pivotably mounted on frame 356 with pivot 360. Slide bracket 358 may pivot on the frame from a rest angle at the desired cutting angle (typically in a range of from about 30° to about 60°, or about 45°, from vertical) which is set by pitch adjustment knob 362 to a tilted up angle at which the blade is fully disengaged from the floor surface (up to at least around 90° or roughly horizontal). In FIG. 26, the desired range of tilt for the slide bracket follows from the way it is pivotably attached to frame vertical 370. In FIG. 26, frame 356 includes a vertical portion 370 and a horizontal base portion 368. Other frame arrangements are certainly possible. Skate 354 (or both skates 354a and 354b) may include a recess or channel closely fitting the base 368 of frame 356. This keeps the frame aligned squarely on the skates, even while adjusting the side to side position. Other means of alignment are also possible, such as a rail and groove, channel, or the like.

Either outside edge of the wheel plate or skates 354 is a guide edge which can be made to follow a chalk line or straight edge for making straight cuts. Accordingly it is advantageous for the frame to be adjustable side to side with respect to the guide edges so that the grinder blade can be located on the center line between the two edges. In this way the grinder will cut on a line a certain distance from the guide edge regardless of which direction one cuts. It is often preferable to cut from the middle of a slab or room out toward the edge, and only a single straight edge or chalk line need be laid to enable two such cuts to form a single line. The side to side adjustment is accomplished in skate assembly 350 by means of the slots in the base portion of the frame. Bolts through the slots fasten into the skates. Thus, the base can be positioned as desired with respect to the skate edges.

FIG. 27 shows a skate 354 in exploded view. Wheels 352 fit into apertures in the skate 354b with axles 351 to hold the wheels in place and set screws 353 to hole the axles in place. Any other known method of attaching wheels in line could be used.

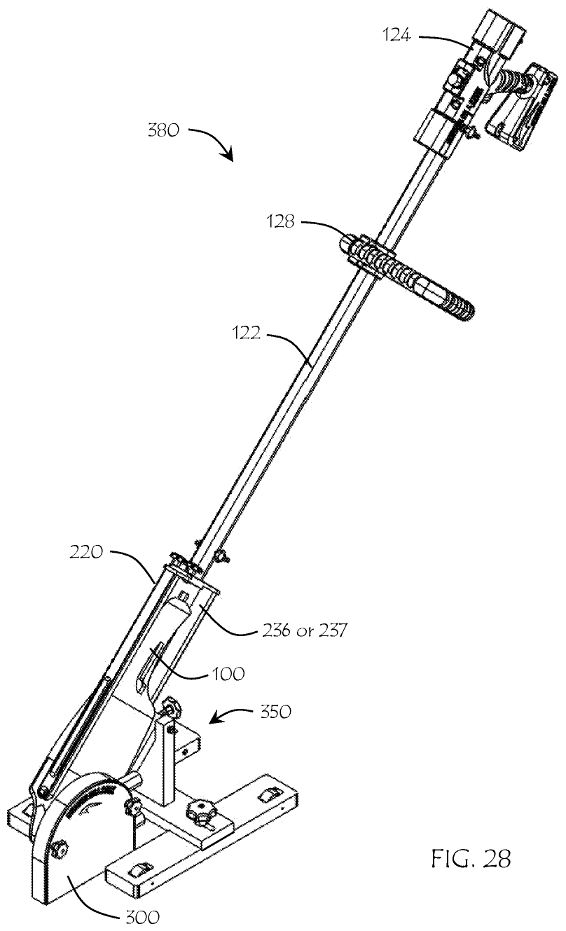

FIG. 28 shows complete extension handle assembly 380 with grinder 100 rigidly mounted in long fork assembly 220 which is attached to shaft 122 with assist handle 128 and main handle 124 also mounted thereon. Seven-inch shroud 300 is in place on the grinder. One can see how the shroud may be installed or removed and as needed because of the space provided between the two skates of the skate assembly 350. Power cord 208 is not shown but in this arrangement may be clipped to shaft 122 in multiple places and plugged into a power outlet on the main handle. The cord is not used to tilt the grinder in this arrangement. Mounting bolts and knobs 366 secure one fork 236 or 237 to the slide bracket of skate assembly 350 through the slot 246 or 247 on the fork. The fork assembly is securely mounted on a slide bracket member of the skate assembly but can easily be adjusted up and down the slide bracket to change the depth of the cut or for different sizes of grinders. The slide bracket also tilts for lifting the blade off the surface or starting a cut gradually.

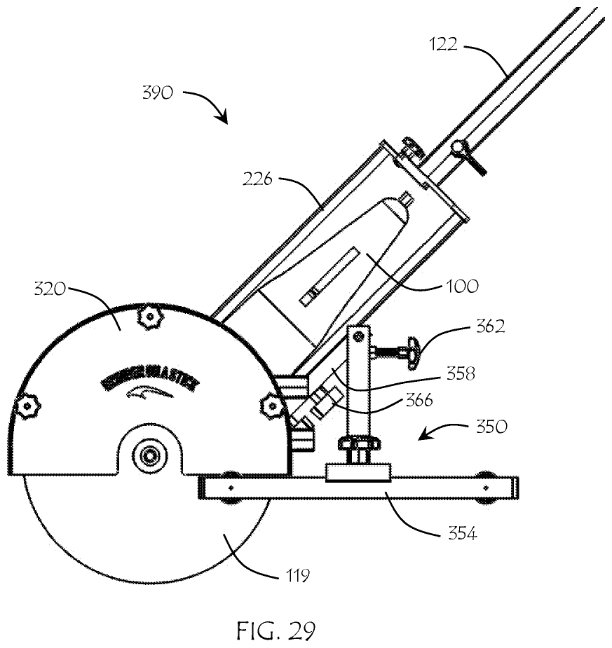

FIG. 29 shows complete extension handle assembly 390 with grinder 100 rigidly mounted in long fork assembly 220 which is attached to shaft 122. Twelve-inch shroud 320 is in place on the grinder. Mounting bolts and knobs 366 secure one fork 236 or 237 to the slide bracket of skate assembly 350 through the slot on the fork. The long fork assembly 226 is securely mounted on a slide bracket 358 of skate assembly 350 but can easily be adjusted with fasteners 366 up and down the slide bracket to change the depth of the cut or for different sizes of grinders. The slide bracket also tilts for lifting the blade off the surface or starting a cut gradually. The angle for cutting can be adjusted with pitch adjustment knob 362.

Vertical operation of the invention.

The equipment may assembled as shown in FIGS. 28 and 29. The inventive vertical shrouds can be easily affixed to the grinder, leveled to be approximately parallel to the floor, and adjusted for the desired depth of cut. The skate (including the width of the fork assembly) is easily adjustable to accommodate any right angle grinder and blade. For straight, accurate cuts, one may lay or chalk line or edge guide board on the surface to be cut. The guide edge of the skate assembly is lined up with the chalk line or butted against the straight edge. The grinder may be tilted up from the surface and turned on as described earlier. Then the blade may be lowered into the surface to begin the cut. The assembly is then pushed forward along the guide board or chalk line to complete the cut. If the blade has been centered as described earlier, the assembly may be turned around 180° and the cut continued in the opposite direction without adjusting the guide board. The adjustable skates allows the user to make quick adjustments in the placement of the skates with a tool-free carriage bolt and tightening knob system. The handheld right-angle grinder is thus turned into a walk-behind floor cutting machine. The in-line wheels cause the skates and the grinder to travel effortlessly alongside the edge guide in a straight and perfect line that cannot be obtained with conventional handheld operation.

Palm Sander Shroud:

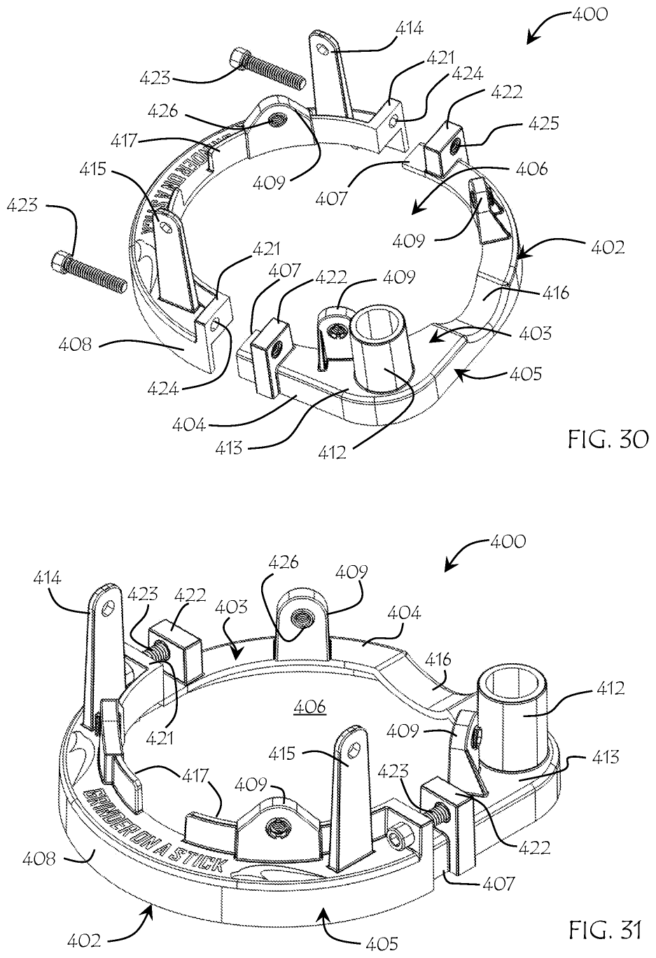

An inventive palm sander shroud accessory enables use of the handle extension system for sanding with a palm sander. FIGS. 30-32 show Palm Sander Shroud 400 exploded, assembled, and mounted on the extension handle system, respectively.

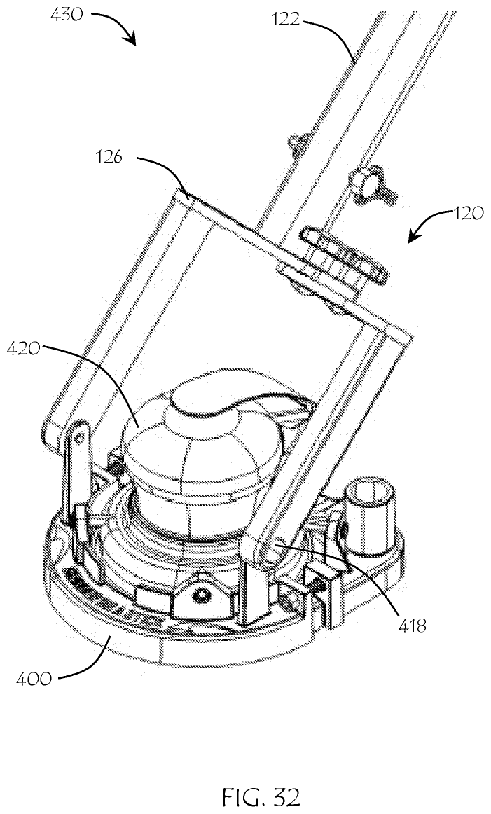

In FIG. 30, sanding shroud 400 has a main body 402 that is like an inverted cup or a cap with a circular hole 406 in the top surface 403 large enough to accommodate a typical palm sander housing, and a downward projecting perimeter wall or rim 405. The main body 402 is formed in two semi-circular sections 404 and 408 which combined form the cap shape. The main body can thus be mounted around a sander housing without removing the sander's backing disc. The ends of the arcs of the two semi-circular sections 404, 408 are adapted to join up by telescoping together, i.e., one half (408) overlaps the other half (404) to form a closed housing. At each end of the arcs of section 408 is an upward-projecting, lead-screw, tab structure 421. At each end of the arcs of section 404 are similar tab structures 422 set back from the telescoping portion 407. These tabs thus match up in pairs at each of the two joints. Tabs 421 on section 408 have through holes 424, and tabs 422 on section 404 have threaded holes 425, and the holes are all directed circumferentially. Bolts or lead screws 423 inserted through holes 424 and threaded into holes 425 can then draw the tab pairs 421, 422 closer together, telescoping the two shroud halves together and tightening or snugging up the shroud around a palm sander housing. Once snugly on the sander (see sander 420 in FIG. 32), a plurality of radially inward directed set screws 426 in other vertical tabs 409 can be tightened up against the sander housing. The otherwise round top 403 of the shroud 400 includes a non-circular enlarged section 413 where a vacuum hose bib 412 may be located. Two fork attachment sites 414 and 415 project upward from the top surface 403 of the main body 402. Each fork attachment site has a hole which may be threaded or otherwise adapted to fixedly or pivotally attach to the corresponding forks of a fork assembly.

Other features for compatibility or strength may be added as needed. For example, indentation 416 may be included to accommodate the usual dust port on the back side of most palm sanders. Vertical support walls 417 are an example of useful stiffening or strengthening structures that could be added. Threaded holes may be tapped in or inserts in this and all other embodiments presented herein.

The sanding shroud can also be adapted for use in tandem or more in a way analogous to the horizontal shroud described earlier. As in FIG. 16, adjustable, swivel connector brackets 192 or equivalent can be added to the shroud to join two or more together. Also, a rubber skirt can be added as with the other shrouds.

FIG. 32 shows the sanding shroud 400 snugged up and secured around sander 120. An embodiment of the extension handle system 120 is bolted to the shroud joining the forks of short fork assembly 126 to the fork attachment projects 414, 415 at pivots 418. The sander may be mounted fixed or pivotably at the pivots.

Palm sanders typically have a debris bag attached to the the tool that provides little benefit of accumulating dust and debris during operation. Vacuum hose bib 412 provides a better way to collect dust generated by sanding. Conventional drywall sanding is performed using metal screens on a pad and pole which is very messy with no collection capability. The inventive shroud with or without the extension handle system makes finishing drywall quick and relatively mess free with an attached vacuum system.

However, drywall sanding involves a mild sanding motion, and most orbital palm sanders rotate at a higher rate than is ideal for drywall sanding. Therefore, it would be advantageous to reduce the rpm's of the typical 12,000-rpm palm sander to around 2,000 rpm's. The next accessory solves this problem.

Variable Speed Controller;

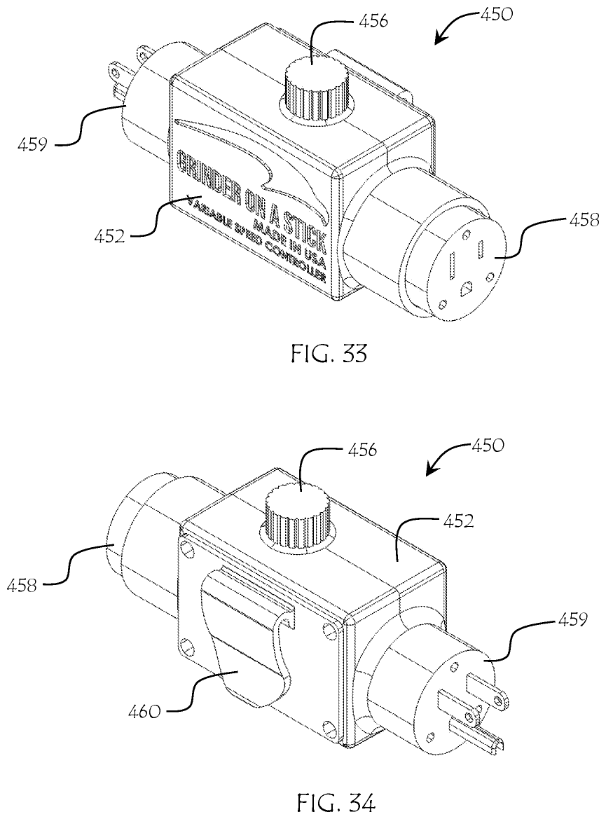

The variable speed controller or adapter will vary the speed or rpm of a electric power tool such as a grinder of sander. FIG. 33 and FIG. 34 show both sides of variable speed controller (“VSC”) 450. VSC 450 was developed specifically for use with the extension handle system, but is generally applicable to any power tool needing variable speed control. VSC 450 includes housing 452, which has a convenient rectangular solid shape. Each end of the housing 452 has an opening in which electrical receptacles or plugs are mounted. At one end is female receptacle 458 which may be used as a tool outlet for plugging in the power cord of a tool. At the opposing end of the housing 452 is male electrical outlet 459 which may be used as an extension cord receptacle to provide power the VSC and the attached tool. On the top side of housing 452 is speed control dial 456. Inside the housing is an AC motor speed control circuit board with a protruding contol shaft on which dial 456 is mounted. Also inside the housing are wires connecting the male outlet 459 to the control circuit board and the female receptable to the control circuit board.

The electronics are the same as described above in connection with housing 152 in FIG. 2. The variable speed controller is preferably chosen for speed reduction of AC (alternating current) motors running on the local voltage and frequency, for compatibility with the grinder or sander or other tool used. The VSC may advantageously be used with embodiments of the extension handle system having just an on/off switch 153 as in the embodiment shown in FIG. 7. The main handle 124 is designed to be compatible with the VSC 450. Male outlet 459 may therefore be plugged directly into any of the one or more female electrical receptacles 157, 158, and the grinder (or other tool) power cord 108 may be plugged into the female receptacle 458 of the VSC in order to power and control the tool. The back side of housing 452 may also have belt clip 460 for use separate from the main handle of an extension system.

Alternate Main Handle Embodiment:

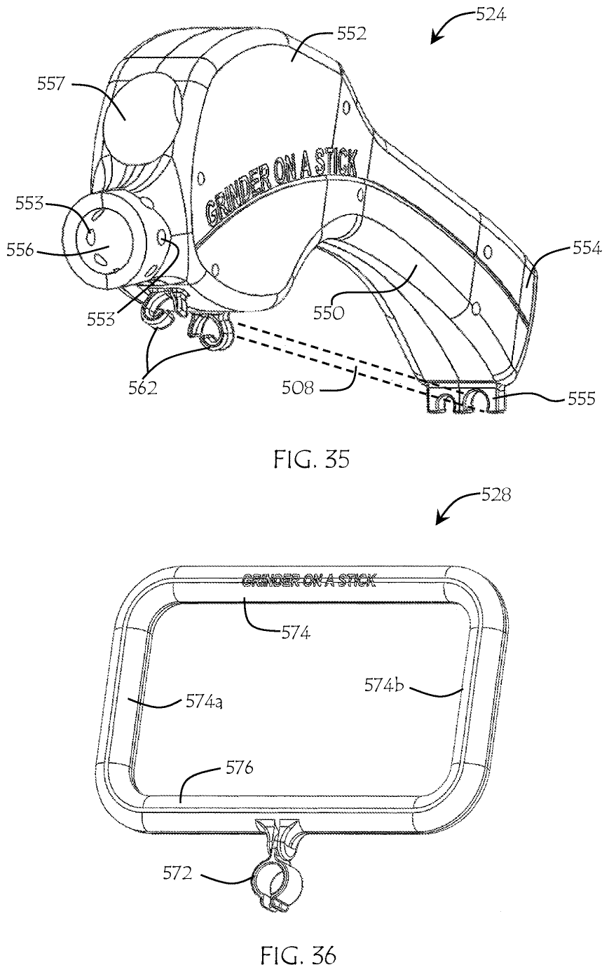

FIG. 35 shows an alternate design for the main handle of the extension handle system. Alternate handle 524 includes main hand grip 550, base 554 attached at the rear or lower end of grip 550, and electrical housing 552 and shaft receptable 556 integrally attached at the upper or front end of grip 550. Base 554 of handle 524 includes cord-lock clips 555. Shaft receptacle 556 is adapted to receive and hold the upper end of shaft 122 and to be secured into place by a wire-lock pin 110a or other type of pin fastener when inserted through one of several holes 553 on handle 524 and through shaft hole 125. The pin may emerge from one of several opposite holes 553 on the opposite side of the handle.

Embodiments of the extension handle system using this handle can be used to operate a grinder in the same was as previously described, using the cord as a lifting system to tilt and level the grinder. For this, the power cord may be routed through cord guide 562, locked into cord-lock clips 555, and then plugged into the female receptacle 557. Male receptacle 559, located at the back of the handle may be used for an extension cord. An on/off power switch or VSC may be housed in the upper part of the handle with the switch or dial located in a convenient place (not shown). The span 508 of power cord running from cord guide 562 to cord lock clips 555 may be engaged with one or more fingers of one hand while the rest of the hand firmly grasps grip 550. Then when pulled, the cord will slide through cord guide 562 and lift the handle of the grinder below. The other hand grasps the assist handle to help steer the grinder. This mode of operation is the same as described in other embodiments above.

Other features may be incorporated as well into handle 524. A wire-lock pin 110 could be used to secure the handle and provide the cord guide. A wire locking post could be provided. A tool grip could be provided. More than one female electrical outlet could be included. Other handle shapes with these features could also be envisioned.

Alternate Assist Handle Embodiment:

FIG. 36 shows an alternate assist handle design for the extension handle system. Assist handle 528 includes shaft attachment clamp system 572, which is analogous to the clamp described above with assist handle 128. As with assist handle 128, assist handle 528 includes a horizontal gripping portion 574 and two vertical gripping portions 575a and 575b. A lower horizontal portion 576 connects the two vertical portions and the horizontal gripping portion 574 connects the top of the two vertical grips, thus making a closed loop. The clamping portion 572 is attached to the lower horizontal portion 576 and makes for easy and adjustable attachment to shaft 122 of an extension handle system.

It should be understood that directional and dimensional words in text or drawings, such as left, right, upper, lower, top bottom, front, rear, etc., as used herein, are not intended to limit the use, orientation or size of any part or assembly shown or described. The meaning of such words should be clear from the context, but the words are usually intended to be interpreted with respect to the orientation seen in a drawing or with respect to a hypothetical operator of a device.

Summary comments incorporated from the provisional priority document:

Angle grinders are handheld exclusively. The “Grinder on a Stick” as the present invention has been dubbed, allows the user to stand up over his work to hold onto the grinder instead of being in the dust and debris. This makes grinding far safer for the user and three to four times faster than grinding on your hands and knees. Grinder on a stick is extremely useful and provides many solutions to the common problems associated with grinding and sanding in the construction and renovation industry. Grinder on a Stick is a highly adjustable and versatile tool that is designed to accommodate all 4½ and 7-inch grinders sold in the USA and around the world. This invention takes a handheld angle grinder and turns it into an upright walk behind prep machine. It includes several accessory options to accommodate many tools for various trades in the construction and renovation industry.

Grinder on a Stick is a highly effective handle that places the user above and away from the grinding process. The current industry standard is to hold the grinder in your hands. Grinder on a Stick allows the user to stand up to operate the grinder with a handle system that attaches the Grinder on a Stick to the grinder. This invention began with finding an easier way of grinding concrete in restoration projects where the user is working in the dust and debris coming off the grinder and doing this on their hands and knees. The idea was to would develop a handle to allow the user to stand up and grind with the same control as the user would have by holding onto the grinder with their own hands. This resulted in the invention of the Grinder on a Stick. The ergonomics of Grinder on a Stick is to duplicate or replicate physical operation of a right-angle grinder on a handle with the same control as holding the grinder in your hands. A grinder has two points of control where your hands hold onto the grinder to operate. If you are right-handed in this example, your right hand would be holding on to the trigger portion of the grinder and your left hand would be holding the side handle. This hand position is exactly the opposite for a left-handed user. This two point position is replicated with the Grinder on a Stick when the main handle is held in your right hand and your left hand is holding on to the weed eater-like handle or assist handle. And just the opposite for left-handed users. This allows the user to manipulate and control the grinder while standing up with the same effect as holding the grinder in their hands. This allows the operator to move the grinder from side to side and back and forth. But there is one other movement a user can perform while having the grinder is their hands, this final movement is to tilt or angle the grinder into low spots or into radius and beveled areas.

The Grinder on a Stick has a main handle grip. This is the handle that holds the electrical outlet the operate the grinder and the extension cords. The power source to the main handle grip has a female electrical outlet coming into the front of the grip where the user would plug in the grinder cord. On the back end of the Grinder of the Grinder a Stick handle is a male electrical outlet to provide power to the Grinder on a Stick using an extension cord. In the middle of this grip is an on and off switch that when in use is directly below the user's thumb. The design of the power source at the back side of the grip handle keeps the extension cord out of harm's way as well. This unique cord keeper accommodates both 12- and 14-gauge cords. It also prevents the extension cords from pulling out during use. It also makes storing the Grinder on a Stick much far more convenient. Where you insert the pole into the main handle grip there are holes that allow the user to rotate the main handle to a straight up and down position of 180 degrees for making vertical cuts and a 90-degree angles for the horizontal grinding. The cord guides have both a fixed cord locking tab and oversized cord guides that allow the grinder's cord to travel freely up to the main handle. Notice that there is an arch in the main grip. This is shaped like this so that as the grinder cord travels up the pole, through the guides, then through the cord guides then past the user's hand grip and then clips into the electrical locking tab at the back of the grip handle. This allows the user to reach down while grinding and pull up the slack on the cord causing the grinder at the other end of the stick to tilt up and down. The forks at the end of Grinder on a Stick accommodate all makes and models of 4½″ to 7″ grinders. The forks adjust in and out to fit all widths of grinders. The 4½″ and 7″ grinders are the most common grinder sizes used in the industry. However, a line of 9″ tools or other sizes is possible. The large grip handle coupled with the assist grip handle gives the user a lot of control over what you can do with the grinder when attached to Grinder on a Stick. Grinder on a Sticks' weed eater-like design puts the user in full control of the grinder to manipulate the tool to do and go wherever the user wants, just as if the user were holding the grinder in his hands. It is more stable and much safer than conventional grinding techniques.

The main handle grip, the assist handle and the cord guides are all made of plastic and will be injection molded. The forks are made of aluminum alloy or steel and will be injection molded. The poles are made of aluminum, steel, or fiberglass or some other useful material. Grinder on a Stick is a highly maneuverable and adjustable handle that attaches to a right-angle grinder allowing the user to perform all aspects of operating a right-angle grinder, while standing up. Grinder on a Stick is a new invention to make using a grinder safer and more effective than grinding on your hands and knees or bending over to cut in vertical thin or crack chaser blade applications. The design of the Grinder on a Stick puts some distance between the user and the dust or sparks created during the grinding process that often have health consequences. The user has far more control over the stability of the grinder itself and far less chance of injury by distancing themselves from the cutting disc and blades by using Grinder on a Stick. Anyone that has regularly used a right-angle grinder knows the dangers of operating these tools and can probably share many personal experiences of being injured. When you operate a grinder on your hands and knees you are so close to the cutting blades that eventually you are going to get cut and perhaps badly. These injuries are entirely avoidable with Grinder on a Stick. This safety factor alone is reason enough to approve the patent for the Grinder on a Stick. Just imagine how many folks are being injured in the United States and around the world that would have been completely avoidable with Grinder on a Stick. Until now, all grinding applications involved fatigue from being hunched over to perform various task, difficulty reaching over your head, hot sparks flying at you when working on metals or grinding on your knees with grinding dust blowing in your face and lungs. With Grinder on a Stick, you have the ease of grinding large areas, installing joints, reaching high areas without risk of falling off a ladder and all accomplished now comfortably standing up. With Grinder on a Stick, the user is standing over his work which allows the user to better see what he is doing and can also work much faster. Typically getting the work done three to four times faster then conventional grinding while extending the life of the abrasives by twice as much. You can tilt it, bend it, extend it, push it, pull it, just like it was in your own hands but without bending over or being on your knees. It is safer, faster and far more user friendly than conventional way of grinding today. The grinder on a Stick can adjust telescopically to reach greater heights or to adjust for the height of the individual using the Grinder on a Stick or can adjust to get further away from the actual grinding process. The assist handle, comparable to a weed eater handle, allows for both right- and left-handed user. It also allows the user to change from flat surface type abrasive blades and diamond cups or horizontal blades, to lock the grinder upright on our skate bracket system at 180-degree angle for vertical blades and change to 90-degree angle for horizontal blades. The large handle grip allows for greater stability and reduces hand fatigue that occurs with prolonged grinding use. Also, the on and off switch is conveniently located below the users thumb to turn the tool on and turn off in case of an emergency. In this industry, cords are very often cut while using these grinders because the grinding blades and the cords are in such close proximity during conventional use. With Grinder on a Stick, it is unlikely that cords will ever be cut because the cord is nowhere near the cutting blades as they are securely hooked to the handle of the Grinder on a Stick.

It is a problem that conventional grinding, performed mostly on your knees or hunched over is exhausting, dangerous, can cause health issues and can result in injuries. Grinder on a Stick provides safety, productivity, reduces health risk and injury, reduces fatigue, saves your body and extends the life of cutters. Based on Grinder on a Stick, one can create amazing walk behind tools for 4½ and 7-inch grinders to go with the Grinder on a Stick. For use with Grinder on a Stick one can develop tools for sanding wood floors, concrete polishers, palm sander shrouds for drywall, wheels to float on, variable speed controls and tandem brackets to operate multiple tools at the same time that all attach to the Grinder on a Stick.

A shroud that allows the user to stand up and walk behind the grinder just doesn't exist in the smaller grinder market until the invention of Grinder on a Stick. The invention of Grinder on a Stick creates a whole new market of tools that can now be available to the 4½ to 7-inch grinder industry. For example, putting a grinder on wheels with a shroud enclosure, then add an adjustable skirting to accommodate the many different blade profile and then offer a water attachment for wet cutting turns an inexpensive hand grinder into a walk behind prep machine. Grinder on a Stick allows us to turn an everyday handheld grinder into a walk behind horizontal prep machine, a vertical wet saw, a wood floor sander and the first of its kind palm sander shroud just to start with.

Invented now is a wet/dry horizontal shroud that possesses some very unique features. This shroud still attaches to the grinder itself by way of the bolt holes provided in every grinder manufactured. These bolt holes exist because they accommodate a side handle that accommodates both left- and right-handed users. They are used to secure the head of the grinder to the Grinder on a Stick. The forks on Grinder on a Stick have to be adjustable because grinders can vary in width by an inch or more depending on the brand or the size of the grinder you are using. Before Grinder on a Stick, all blades rode directly on the surface being abraded. All grinder manufacturers have different profile heights and dimensions. Therefore, it is necessary to make these shrouds extremely adjustable. All of the inventive shrouds are uniquely designed with a range of adjustments to accommodate any grinder made in the industry today. The mounting flange on the shroud for the Grinder on a Stick has adjustable set screws that attaches the shroud to grinder. I placed adjustable caster wheels on the shroud to make the shroud and blades to hover over the surface being ground or sanded. These caster wheels move up and down which allows the user to adapt to the height of every type of grinder, backer pad, diamond cup, silicon carbide disc, sanding disc and all other types of abrasives available on the market today. The casters brackets are designed to swing out for stabilization so the grinder can glide over the surface being ground evenly and without gouging. The adjustable caster wheels suspend the blades or cups at the same level so to have a smooth profiled surface. The blades just coast over the surface being sanded or ground similar to how a wood planer works to make 2×4's and other boards that need to be even and smooth. Conventional shrouds can gouge and tear up the surface because there is nothing to stop the blades from digging in or gouging the surface. This is especially true on rough and/or soft concrete. The shrouds have adjustable rubber skirting that allows the user to adjust the skirting up or down to accommodate the many different types of blades. I also provided a water spicket attachment which allows for wet grinding with diamond cups and blades. I also provided duel 1″ vacuum lines that provide much greater suction than conventional 2″ lines. The horizontal shroud also has a removable side cover to allow the user to grind closely along base boards or other vertical walls applications and is made of aluminum alloy or other metal or hard plastics for greater longevity. The shroud is an enclosed design that separates the grinder motor from coming into contact with the water or dust produce inside this shroud. The shroud attaches to the arbor mount where the blades are attached. The arbor mount is a sealed unit that is outside of the grinder's motor casing. After connecting the shroud to that arbor mount, water and dust cannot reach the motor of the grinder. The shroud can bracket multiple grinders together in tandem in a side-by-side position to double the preparation surface area with a single bracket.

The swivel bracket attaches to the fork stem to eliminate any influence the operator may have on the tool itself. Unlike janitorial floor machines that move back and forth by pressure on the handle up or down. This swivel removes that reaction because it disconnects the handle from the machine.

Another innovation is a shroud for a palm sander that is adjustable to fit on any palm sander in the industry. This exclusive design allows the user to turn a palm sander into a dry wall sander or wood floor sander or for any project that requires a palm sander. Instead of using sticks and sanding screens, the palm sander with its vacuum system takes the sheet rock dust and puts it into the shop vac. This is a shroud for a palm sander to allow the user to stand up to sand and it also has a tandem bracket to mount two sanders together to sand twice as fast. Also, there is not a palm sander shroud available in the industry today.

The related inventions include a variable speed controller. This adapter is designed to go into the tool outlet in the handle of the Grinder on a Stick to regulate rpm's in the tool being operated. Specifically, it was designed to drop the rpm's in a palm sander for sanding sheet rock. This would also allow users to alter the rpm's or regulate the speed for other tools.

Vertical shrouds accommodate all inverted blades including thin, crack chaser blades, demo blades and concrete cutting blades. This vertical shroud is mounted on so-called “skates.” These are the first of their kind skates that allow the inverted grinder to float smoothly along on wheels. One can follow a chalk line or better yet place the skate up to a piece of siding and roll the skates along the siding for a perfectly straight cut with this inverted grinder bracket with skates. The grinder is mounted on a slide bracket that allows the grinder to slide up and down to change the depth of the cut and the different sizes of grinders. This shroud has a water attachment for wet cuts and a rubber adjustable skirting that will keep the water contained during wet cuts and the dust contained in dry cuts. This shroud is waterproof to protect the grinder motor from water damage. The 4½ to 7-inch grinder industry doesn't have wet grinding capability.

Grinder on a Stick is a new invention that allows the user to preform many and as there is not another handle invented to hold a grinder or a palm sander for walk behind or upright use. Grinder on a Stick literally turns a commonly used handheld grinder into a walk-behind upright preparation machine capable of performing the tasks of many machines in various trades and at a fraction of the cost. Grinder on a Stick is extremely useful as it can be used in place of expensive machines used in the construction and renovation industry. Grinder on a Stick can replace walk behind concrete diamond grinding prep machines. It can replace floor machines. It can be used in place of a wood floor sanding machine. It can be used in place of vertical wet saws. It can be used in place of demo saws. It can be used in place of screens and poles to sand down the sheet rock in the drywall industry. The palm sander shroud is the first of its kind. It can be used to finish all types of woodwork, and it can do it all without making a mess from dust and debris found in commonly used equipment. Grinder on a Stick can perform all of these tasks but none of these other tools can claim they can do all that Grind on a Stick can do and at a fraction of the cost of these other tools. With the invention of Grinder on a Stick has created an enormous opportunity for accompanying inventions. Being the first of its kind makes everything you attach to it new. Many of the features on the invention can only be found in larger expensive machines. Not much is out there for 4½ and 7-inch right angle grinders industry. I have been in this industry for nearly 50 years and all I have ever seen available in accessories for 4½ and 7-inch grinders is a simple rubber dust shroud. That's it and even those shrouds don't have adjustable skirting, so they just suck down to the surface making them difficult to operate. Not the inventive shrouds because they can be adjusted up or down to prevent that problem. Another first for the small grinder user. Having Grinder on a Stick allows the user such versatility for uses for example, you would never consider sanding a wood floor with a right-angle grinder because it would tear the floor up. But when you put a shroud with adjustable caster wheels on it, then attach additional grinders with tandem brackets, then drop the rpm's with a variable speed controller, you just made yourself an awesome wood floor sanding machine at a fraction of the cost of purchasing a floor sander. The variable speed outlet controller will be the first of its kind in the market for making all tools variable speed. The vertical shrouds also protect the motor from getting wet because the vertical shroud is also waterproof. The bracing and the skates on the vertical shrouds are new. This is the first of its kind for mounting a right-angle grinder at 180 degrees on skates. The skates are the plates that hold the wheels in an inline direction. This allows the user to stand up and glide along in a straight line. The adjustable rubber skirting is a first of its kind to adjust to the many different grinders and blades yet being able to adjust the skirting down to keep in the dust and water inside the shroud. The suction system on these shrouds is also new with two one-inch intake lines instead of one two-inch line that are on most common vacuums. The dual lines increase the suction to produce a greater draw when vacuuming up dust and water. The removable baseboard cover on the horizontal shrouds replaces the conventional flip up cover that in conventional grinder never gets completely out of the way because it is still attached to the shroud and just bent upwards. The baseboard cover is removable, so it is completely out of the way. The other issue with conventional flip-up baseboard covers is they simple break off after a couple of months of use.

The following points and comments may be made. Grinder on a Stick is the first of its kind to operate a right-angle grinder standing up and not have your hands directly on the grinder. The main handle is the first of its kind to have electrical outlets going in and out to operate a grinder or sander. The arch in the handle allows the user to tilt the grinder up and down is first of its kind for a grinder or sander. The ferrules or guides are a first of their kind to manipulate the movement of the grinder or sander. The cord locking system on Grinder on a Stick is the first of its kind for operating a grinder or sander. The large assist handle is the first of its kind for operating a grinder standing up using a grinder or sander.

The following features are believed to be novel: The adjustable fork design for widening or narrowing the width of the forks to fit all 4½ and 7 inch grinders; The design of the stem to accommodate and hold on to the grinder; The concept of Grinder on a Stick for the use of operating grinders and sanders; the Variable speed controller to alter the rpm's on tools; The horizontal shroud design for attaching a grinder to the shroud on the arbor mount flange; The adjustable rubber skirting design to accommodate various grinders and cutters on grinders; The removable baseboard cover design; The dual one inch vacuum system; The design for the cover's construction on the vertical shroud; The adjustable rubber skirting design; The flange shroud mounting to attach the shroud to a grinder; The one inch vacuum system; The skates designed to mount grinders to with wheels; The design for the mounting bracket for holding and adjusting the position of the grinder; The tilting tower design for positioning the grinder on a teeter totter pivot bracket; The adjustable fork design; The wheel design in the skates; The whole concept for the first of its kind for creating a tool for inverting a grinder; The shroud design for the palm sander; The handle system for the palm sander; All of adjustment pins and bolts for the palm sander; The shape of the palm sander shroud; The velcro system for palm sander shroud; and The first-of-a-kind shroud for a palm sander.

Grinder on a Stick is a handle that operates angle grinders without having to hold the grinder with your hands to operate. Grinders have two points of control application as one hand is on the trigger portion of the grinder and the other hand is handle is threaded into the side of the grinder. These two points of operation are duplicated with the Grinder on a Stick. The large main handle grip is the equivalent of holding the trigger handle on the grinder, and the assist handle for holding onto the side handle of the grinder is much like a weed-eater handle. The grinder is attached to the mounting forks at the end of the Grinder on a Stick by way of threading the bolts through the forks and into the threaded handle grips holes on the side of the grinder. The grinder's cord is then placed into the cord guides or ferrules of the pole of the Grinder on a Stick that passes through a final guide on the main handle grip. There is an arch shape in the main grip where the user's hand holds the grip as the grinder cord passes through this arch just below the user's hand and is hooked into the special cord locking clip at the back of the handle. The user can then reach down and pull on the grinder's cord during operation and pull up and down on the cord causing the grinder at the end of the stick to tilt up and down. This allows the user to duplicate all of the moves that a handheld grinder can perform while standing up. The user can then make the grinder go back and forth and side to side and now tilt. With the tilting action, the user can cause the grinder to dip into low areas and up beveled surface on the move completing all the moves a user can perform holding the grinder in his hands but now standing up. This new invention has a line of accompanying shrouds and attachments to convert Grinder on a Stick into many different tools to serve the construction and renovation industries.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

1. An extension handle system for a handheld power tool comprising, a shaft with a first end opposite a second end;
a fork assembly attached to the first end of the shaft;
an assist handle attached to the shaft between the two ends; and
a main handle attached to the second end;
wherein the main handle comprises a cord guide and a cord lock.

2. The extension handle system of claim 1 wherein the main handle further comprises a power switch, a male electrical plug, and a female electrical receptacle.

3. The extension handle system of claim 2 wherein the power switch is an on/off switch.

4. The extension handle system of claim 2 wherein the power switch is a variable speed control with a dial.

5. The extension handle system of claim 2 wherein the main handle further comprises a hand grip portion.

6. The extension handle system of claim 5 wherein a power cord passing through said cord guide and locked in said cord lock would define a span of said power cord residing parallel to and spaced apart from the hand grip portion.

7. The extension handle system of claim 6 wherein a wire-lock pin fastens the main handle onto the shaft and a wire retainer of the wire-lock pin is the cord guide.

8. The extension handle system of claim 7 wherein the wire retainer comprises a wire loop; and the main handle comprises a wire mount protruding from the main handle in a shape and location to hold the wire loop.

9. The extension handle system of claim 2 wherein the fork assembly comprises two transverse members, two parallel and spaced apart forks, one said fork projecting from each of the two transverse members;
wherein the transverse members are adjustably fastened together and adapted to set the fork spacing to a predetermined value.

10. The extension handle system of claim 9 wherein the fork assembly includes pivots adapted to pivotably attach a right-angle grinder between the two forks.

11. The extension handle system of claim 10 wherein the fork assembly includes a post projecting from one of the transverse members in the opposite direction from the forks, and the post includes a through hole that is aligned with a through hole near the first end of the shaft, and a pin passing through the through holes attaches the fork assembly to the shaft.

12. The extension handle system of claim 1 wherein the shaft is modular and storable in shorter lengths.

13. The extension handle system of claim 1 wherein the assist handle includes a vertical gripping portion and a horizontal gripping portion.

14. The extension handle system of claim 1 further comprising a vertical grinder shroud mountable on a grinder comprising:
a two-piece housing comprising an inner shell and an outer shell; and
fasteners that hold the shells together;
wherein the inner shell has an opening with a surrounding collar projecting from the inner shell, the collar adapted to fit around the arbor mount of a right-angle grinder and having set screws to hold it thereon.

15. The extension handle system of claim 13 further comprising a skate assembly comprising:
one or more wheel skates having four wheels spaced apart in a square or rectangular arrangement;
a frame supported on and adjustably fastened to the one or more skates;
a slide bracket pivotably attached to the frame with fasteners for mounting the extension handle system; and
a pitch adjustment nob that sets a rest angle for the slide bracket.

16. The extension handle system of claim 14 further comprising a space through the one or more wheel skates;
whereby, when a grinder has a vertical shroud mounted and the grinder is mounted in the fork assembly which is bolted to the slide pivot at a predetermined rest angle, and the shroud is set to ride at or near a floor surface, the space prevents interference between the shroud and wheel skates.

17. The extension handle system of claim 1 further comprising a horizontal shroud mountable on a grinder comprising:
a shroud body with an opening in the middle;
a collar with one or more set screws projecting upward around the opening;
one or two vacuum hose ports projecting upward from the body;
a plurality of stabilizer brackets attachable to the top of the body and projecting radially outward from the body; and
a plurality of swivel caster wheels attachable to the stabilizer brackets.

18. The extension handle system of claim 1 further comprising a sander shroud comprising:
a generally circular, shroud body comprising two semicircular half bodies with an opening in the middle when assembled;
a lead-screw tab structures that pull the two semicircular half bodies together to form the assembled shroud body; and
two fork attachment sites projecting upward from the top of the body.

19. A fork assembly comprising:
two transverse members, two parallel and spaced apart forks, one said fork projecting from each of the two transverse members;
a post projecting from one of the transverse members in the opposite direction from the forks;
wherein the transverse members are adjustably fastened together and adapted to set the fork spacing to a predetermined value.

20. A horizontal grinder shroud comprising:
a shroud body with an opening in the middle;
a collar with one or more set screws projecting upward around the opening;
two vacuum hose ports projecting upward from the body;
a plurality of stabilizer brackets attachable to the top of the body and projecting radially outward from the body; and
a plurality of swivel caster wheels attachable to the stabilizer brackets.

21-24. (canceled)
